(19) United States
(12) Patent Application Publication
(10) Pub. No.: US 2013/0157856 A1
(43) Pub. Date: Jun. 20, 2013

(54) Agrochemical Mixtures for Increasing the Health of a Plant

(71) Applicants: Markus Gewehr, Kastellaun (DE); Martin Steiniger, Bad Duerkheim (DE); Andreas Haase, Moscow (RU); Marco-Antonio Tavares-Rodrigues, Sao Paulo (BR)

(72) Inventors: Markus Gewehr, Kastellaun (DE); Martin Steiniger, Bad Duerkheim (DE); Andreas Haase, Moscow (RU); Marco-Antonio Tavares-Rodrigues, Sao Paulo (BR)

(73) Assignee: BASF SE, Ludwigshafen (DE)

(21) Appl. No.: 13/818,246

(22) PCT Filed: Aug. 22, 2011
(86) PCT No.: PCT/EP2011/064345

§ 371 Date: Feb. 21, 2013

Related U.S. Application Data
(60) Provisional application No. 61/376,289, filed on Aug. 24, 2010.

(30) Foreign Application Priority Data
Aug. 24, 2010 (EP) 10173895.3

(51) Int. Cl. A01N 57/20; A01N 43/56; A01N 43/40

(52) U.S. Cl. CPC A01N 57/20; A01N 43/40; A01N 43/56
USPC 504/128

(57) ABSTRACT

The present invention relates to an agrochemical mixture for increasing the health of a plant, comprising as active compounds:
1) a fungicidal compound (I) selected from the group of strobilurins consisting of pyraclostrobin, azoxystrobin, dimoxystrobin, enestroburin, fluoxastrobin, kresoxim-methyl, metominostrobin, orysastrobin, picoxystrobin, pyribencarb, trifloxystrobin, pyrametostrobin, pyraoxystrobin, coumoxystrobin, coumethoxystrobin, triclopyricarb (=chlorodincarb), fenaminostrobin (=diclofenoxystrobin), flufenoxystrobin, 2-(2-(6-(3-chloro-2-methyl-phenoxy)-5-fluoro-pyrimidin-4-yloxy)-phenyl)-2-methoxyimino-N-methyl-acetamide, 3 -methoxy-2-(2-(N-(4-methoxy-phenyl)-cyclopropane-carboximidoylsulfanylmethyl)-phenyl)-acrylic acid methyl ester, methyl (2-chloro-5-[1-(3 -methylbenzyloxyimino)ethyl]benzyl)carbamate and 2-(2-(3-(2,6-dichlorophenyl)-1-methyl -allylideneaminooxymethyl)-phenyl)-2-methoxyimino-N methyl-acetamide; and
2) at least one herbicidal compound (II) selected from the group of imidazolinones consisting of imazamethabenz-methyl, imazamox, imazapic, imazapyr, imazaquin and imazethapyr; or an agriculturally acceptable salt thereof; and
3) a second herbicidal compound (III) selected from the group consisting of glyphosate and glufosinate; or an agriculturally acceptable salt thereof;
   in synergistically effective amounts.

In addition, the invention relates to an agrochemical composition for increasing the health of a plant, comprising a liquid or sold carrier and a mixture as defined above.

The present invention also relates to a method for synergistically increasing the health of a plant, which is tolerant to a herbicidal compound (III), wherein the plant, the locus where the plant is growing or is expected to grow or plant propagation material from which the plant grows is treated with an effective amount of a mixture as defined above.

Furthermore, the present invention relates to the use of a mixture as defined above for synergistically increasing the yield of a plant wherein the treated plant is tolerant to a herbicidal compound (III).

The present invention relates to an agrochemical mixture for increasing the health of a plant, comprising as active compounds:

1) a fungicidal compound (I) selected from the group of strobilurins consisting of pyraclostrobin, azoxystrobin, dimoxystrobin, enestroburin, fluoxastrobin, kresoxim-methyl, metominostrobin, orysastrobin, picoxystrobin, pyribencarb, trifloxystrobin, pyrametostrobin, pyraoxystrobin, coumoxystrobin, coumethoxystrobin, triclopyricarb (=chlorodincarb), fenaminostrobin (=diclofenoxystrobin), flufenoxystrobin, 2-(2-(6-(3-chloro-2-methyl-phenoxy)-5-fluoro-pyrimidin-4-yloxy)-phenyl)-2-methoxyimino-N-methylacetamide, 3-methoxy-2-(2-(N-(4-methoxy-phenyl)-cyclopropane-carboximidoylsulfanylmethyl)-phenyl)-acrylic acid methyl ester, methyl (2-chloro-5-[1-(3-methylbenzyloxyimino)ethyl]benzyl)carbamate and 2-(2-(3-(2,6-dichlorophenyl)-1-methyl-allylideneaminooxymethyl)-phenyl)-2-methoxyimino-N methyl-acetamide; and

2) at least one herbicidal compound (II) selected from the group of imidazolinones consisting of imazamethabenz-methyl, imazamox, imazapic, imazapyr, imazaquin and imazethapyr; or an agriculturally acceptable salt thereof; and

3) a second herbicidal compound (III) selected from the group consisting of glyphosate and glufosinate; or an agriculturally acceptable salt thereof;

in synergistically effective amounts.

In addition, the invention relates to an agrochemical composition for increasing the health of a plant, comprising a liquid or sold carrier and a mixture as defined above.

The present invention also relates to a method for synergistically increasing the health of a plant, which is tolerant to a herbicidal compound (III), wherein the plant, the locus where the plant is growing or is expected to grow or plant propagation material from which the plant grows is treated with an effective amount of a mixture as defined above.

Furthermore, the present invention relates to the use of a mixture as defined above for synergistically increasing the yield of a plant wherein the treated plant is tolerant to a herbicidal compound (III).

Moreover, the present invention relates to the use of a mixture as defined above for synergistically increasing a plant's tolerance against abiotic stress wherein the treated plant is tolerant to a herbicidal compound (III).

Within the scope of the invention, the health of a plant is increased synergistically. Thus, the term “synergistically effective amount” refers to the fact that the purely additive effect (in mathematical terms) of the application of the individual compounds is surpassed by the application of the inventive mixture. The word “synergy” can be derived from the Greek word “syn-ergos” which means “working together”. Accordingly, a synergistic effect may be based upon an interactive manner resulting in an unexpected result—in this case, an unexpected increase of the health of a plant. The synergistic increase of the health of a plant according to the present invention, is more than surprising, since it is known that fungicidal compounds (such as pyraclostrobin) and herbicides (such as glyphosate or imazethapyr) have completely different mode of actions. On the contrary to what can be expected, they “work together” and can therefore be regarded as synergistic.

The term “effective amount” denotes an amount of the inventive mixtures, which is sufficient for achieving the synergistic plant health effects, in particular the yield effects as defined herein. More exemplary information about amounts, ways of application and suitable ratios to be used is given below. The skilled artisan is well aware of the fact that such an amount can vary in a broad range and is dependent on various factors, e.g. the treated cultivated plant as well as the climatic and soil conditions.

US 2003/0060371 discloses a method of improving the yield and vigor of an agronomic plant by applying a composition that includes an active agent such as a diazole fungicide or a strobilurin-type fungicide. If desirable, such compositions can also include herbicides, insecticides, nematicides, acarizicides, fungicides, and the like, growth factors and fertilizers. The particular ternary and quaternary mixtures of the present application as well as the synergistic plant health or synergistic yield increasing effects, are not disclosed therein.

WO 2006/066810 discloses inter alia mixtures of orysastrobin and herbicides selected imazethapyr, imazamox, imazapyr, imazapic and dimethenamid-p. The particular ternary and quaternary mixtures of the present application as well as the synergistic plant health or synergistic yield increasing effects, are not disclosed therein.

US 2006/111239 discloses mixtures of pyraclostrobin and glyphosate in modified leguminoses.

WO 07/115,944 relates to herbicidal mixtures of an imidazolinone herbicide and an adjuvant.

WO 08/116,730 relates to combinations of active substances, comprising a known herbicide selected from gyphosate derivatives, cyclohexenone-oximene, imidazolinone derivatives, dinitroaniline derivates, amide derivatives and quaternary ammonium salts, and at least one fungicidal active substance, said combinations being suitable for combating undesired phytopathogenic fungi.

It is already known from the literature that the compounds (I), which are generally referred to as strobilurins, are capable of bringing about increased yields in crop plants in addition to their fungicidal action (Koehle H. et al. in Gesunde Pflanzen 49 (1997), pages 267-271; Glaab J. et al. Planta 207 (1999), 442-448)).

None of these references disclose, however, the synergistic effects of the ternary and quaternary mixtures as defined at the outset.

All fungicide active ingredients covered by the generic name “strobilurine” are structurally derived from the natural compound “Strobilurin A”. This natural compound named the entire class because of the same mode of action, which is the inhibition of the cytochrome bc1 at Qo site of complex III of the respiration chain. A further sub-classification by chemical names is possible, such as methoxy-acrylates, oximino-acetamides or benzyl-carbamates. However, all compounds can be called “strobilurines” due to the same mode of action and the close chemical structure, containing the same sub-structure elements (pharmacophore, side-chain) than the natural compound.

The compounds (I), (II), (III) and (IV) as well as their pesticidal action and methods for producing them are generally known. For instance, the commercially available compounds can be found in “The Pesticide Manual, 15th Edition, British Crop Protection Council (2009)” among other publications. In addition, many of the listed compounds, such as the Qol (Quinone outside Inhibitor)-fungicides are listed in the FRAC Code List©. FRAC (Fungicide Resistance Action Committee) is a Specialist Technical Group of CropLife International (Formerly Global Crop Protection Federation, GCPF).

In crop protection, there is a continuous need for compositions that improve the health of plants. Healthier plants are desirable since they result among others in better yields and/or a better quality of the plants or crops. Healthier plants also better resist to biotic and/or abiotic stress. A high resistance against biotic stresses in turn allows the person skilled in the art to reduce the quantity of pesticides applied and consequently to slow down the development of resistances against the respective pesticides.

It was therefore an object of the present invention to provide a pesticidal composition which solves the problems outlined above, and which should, in particular, improve the health of plants, in particular the yield and/or quality of plants.

We have found that these objects are in part or in whole achieved by using the mixtures as defined in the outset.

Within the mixtures according to the present invention, compound (I) is selected from the group of strobilurins consisting of pyraclostrobin (I-1), azoxystrobin (I-2), dimoxystrobin (I-3), enestroburin (I-4), fluoxastrobin (I-5), kresoxim-methyl (I-6), metominostrobin (I-7), orysastrobin (I-8), picoxystrobin (I-9), pyribencarb (I-10), trifloxystrobin (I-11), pyrametostrobin (I-12), pyraoxystrobin (I-13), coumoxystrobin (I-14), coumethoxystrobin (I-15), triclopyricarb (=chlorodincarb) (I-16), fenaminostrobin (=diclofenoxystrobin) (I-17), flufenoxystrobin (I-18), 2-(2-(6-(3-chloro-2-methyl-phenoxy)-5-fluoro-pyrimidin-4-yloxy)-phenyl)-2-methoxyimino-N-methyl-acetamide (I-19), 3-methoxy-2-(2-(N-(4-methoxy-phenyl)-cyclopropane-carboximidoylsulfanylmethyl)phenyl)-acrylic acid methyl ester (I-20), methyl (2-chloro-5-[1-(3-methylbenzyloxyimino)-ethyl]benzyl)-carbamate (I-21) and 2-(2-(3-(2,6-dichlorophenyl)-1-methyl-allylideneaminooxymethyl)-phenyl)-2-methoxyimino-N methyl-acetamide (I-22).

In one embodiment, compound (I) is selected from the group of strobilurins consisting of pyraclostrobin (I-1), azoxystrobin (I-2), dimoxystrobin (I-3), enestroburin (I-4), fluoxastrobin (I-5), kresoxim-methyl (I-6), metominostrobin (I-7), orysastrobin (I-8), picoxystrobin (I-9), trifloxystrobin (I-11), pyrametostrobin (I-12), pyraoxystrobin (I-13), coumoxystrobin (I-14), coumethoxystrobin (I-15), triclopyricarb (=chlorodincarb) (I-16), fenaminostrobin (=diclofenoxystrobin) (I-17), flufenoxystrobin (I-18), 2-(2-(6-(3-chloro-2-methyl-phenoxy)-5-fluoro-pyrimidin-4-yloxy)-phenyl)-2-methoxyimino-N-methylacetamide (I-19), methyl (2-chloro-5-[1-(3-methylbenzyloxyimino)-ethyl]benzyl)carbamate (I-21) and 2-(2-(3-(2,6-dichlorophenyl)-1-methyl-allylideneaminooxymethyl)phenyl)-2-methoxyimino-N methyl-acetamide (I-22).

In another embodiment, compound (I) is selected from the group of strobilurins consisting of pyraclostrobin (I-1), azoxystrobin (I-2), dimoxystrobin (I-3), enestroburin (I-4), fluoxastrobin (I-5), kresoxim-methyl (I-6), metominostrobin (I-7), orysastrobin (I-8), picoxystrobin (I-9), trifloxystrobin (I-11), pyrametostrobin (I-12), pyraoxystrobin (I-13), coumoxystrobin (I-14), coumethoxystrobin (I-15), 2-(2-(6-(3-chloro-2-methyl-phenoxy)-5-fluoro-pyrimidin-4-yloxy)-phenyl)-2-methoxyimino-N-methyl-acetamide (I-19), methyl (2-chloro-5-[1-(3-methylbenzyloxyimino)-ethyl]benzyl)-carbamate (I-21) and 2-(2-(3-(2,6-dichlorophenyl)-1-methyl-allylideneaminooxymethyl)-phenyl)-2-methoxyimino-N methyl-acetamide (I-22).

Within the mixtures according to the present invention, compound (II) is selected from the group of imidazolinones consisting of imazamethabenz-methyl (II-1), imazamox (II-2), imazapic (II-3), imazapyr (II-4), imazaquin (II-5) and imazethapyr (II-6) or an agriculturally acceptable salt thereof.

Within the mixtures according to the present invention, compound (III) is selected from the group consisting of glyphosate (III-1) and glufosinate (III-2) or an agriculturally acceptable salt thereof.

Within table 1, the following abbreviations are used: No.=number of the respective mixture; (I) is compound (I); (II) is compound (II) and (III) is compound (III) as defined above.

TABLE 1

| No. | (I) | (II) | (III) |
|---|---|---|---|
| M-1 | (I-1) | (II-1) | (III-1) |
| M-2 | (I-1) | (II-2) | (III-1) |
| M-3 | (I-1) | (II-3) | (III-1) |
| M-4 | (I-1) | (II-4) | (III-1) |
| M-5 | (I-1) | (II-5) | (III-1) |
| M-6 | (I-1) | (II-6) | (III-1) |
| M-7 | (I-2) | (II-1) | (III-1) |
| M-8 | (I-2) | (II-2) | (III-1) |
| M-9 | (I-2) | (II-3) | (III-1) |
| M-10 | (I-2) | (II-4) | (III-1) |
| M-11 | (I-2) | (II-5) | (III-1) |
| M-12 | (I-2) | (II-6) | (III-1) |
| M-13 | (I-3) | (II-1) | (III-1) |
| M-14 | (I-3) | (II-2) | (III-1) |
| M-15 | (I-3) | (II-3) | (III-1) |
| M-16 | (I-3) | (II-4) | (III-1) |
| M-17 | (I-3) | (II-5) | (III-1) |
| M-18 | (I-3) | (II-6) | (III-1) |
| M-19 | (I-4) | (II-1) | (III-1) |
| M-20 | (I-4) | (II-2) | (III-1) |
| M-21 | (I-4) | (II-3) | (III-1) |
| M-22 | (I-4) | (II-4) | (III-1) |
| M-23 | (I-4) | (II-5) | (III-1) |
| M-24 | (I-4) | (II-6) | (III-1) |
| M-25 | (I-5) | (II-1) | (III-1) |
| M-26 | (I-5) | (II-2) | (III-1) |
| M-27 | (I-5) | (II-3) | (III-1) |
| M-28 | (I-5) | (II-4) | (III-1) |
| M-29 | (I-5) | (II-5) | (III-1) |
| M-30 | (I-5) | (II-6) | (III-1) |
| M-31 | (I-6) | (II-1) | (III-1) |
| M-32 | (I-6) | (II-2) | (III-1) |
| M-33 | (I-6) | (II-3) | (III-1) |
| M-34 | (I-6) | (II-4) | (III-1) |
| M-35 | (I-6) | (II-5) | (III-1) |
| M-36 | (I-6) | (II-6) | (III-1) |
| M-37 | (I-7) | (II-1) | (III-1) |
| M-38 | (I-7) | (II-2) | (III-1) |
| M-39 | (I-7) | (II-3) | (III-1) |
| M-40 | (I-7) | (II-4) | (III-1) |
| M-41 | (I-7) | (II-5) | (III-1) |
| M-42 | (I-7) | (II-6) | (III-1) |
| M-43 | (I-8) | (II-1) | (III-1) |
| M-44 | (I-8) | (II-2) | (III-1) |
| M-45 | (I-8) | (II-3) | (III-1) |
| M-46 | (I-8) | (II-4) | (III-1) |
| M-47 | (I-8) | (II-5) | (III-1) |
| M-48 | (I-8) | (II-6) | (III-1) |
| M-49 | (I-9) | (II-1) | (III-1) |
| M-50 | (I-9) | (II-2) | (III-1) |
| M-51 | (I-9) | (II-3) | (III-1) |
| M-52 | (I-9) | (II-4) | (III-1) |
| M-53 | (I-9) | (II-5) | (III-1) |
| M-54 | (I-9) | (II-6) | (III-1) |
| M-55 | (I-10) | (II-1) | (III-1) |
| M-56 | (I-10) | (II-2) | (III-1) |
| M-57 | (I-10) | (II-3) | (III-1) |
| M-58 | (I-10) | (II-4) | (III-1) |
| M-59 | (I-10) | (II-5) | (III-1) |
| M-60 | (I-10) | (II-6) | (III-1) |
| M-61 | (I-11) | (II-1) | (III-1) |
| M-62 | (I-11) | (II-2) | (III-1) |
| M-63 | (I-11) | (II-3) | (III-1) |
| M-64 | (I-11) | (II-4) | (III-1) |
| M-65 | (I-11) | (II-5) | (III-1) |
| M-66 | (I-11) | (II-6) | (III-1) |
| M-67 | (I-1) | (II-1) | (III-2) |
| M-68 | (I-1) | (II-2) | (III-2) |
| M-69 | (I-1) | (II-3) | (III-2) |
| M-70 | (I-1) | (II-4) | (III-2) |
| M-71 | (I-1) | (II-5) | (III-2) |
| M-72 | (I-1) | (II-6) | (III-2) |
| M-73 | (I-2) | (II-1) | (III-2) |
| M-74 | (I-2) | (II-2) | (III-2) |
| M-75 | (I-2) | (II-3) | (III-2) |
| M-76 | (I-2) | (II-4) | (III-2) |
| M-77 | (I-2) | (II-5) | (III-2) |
| M-78 | (I-2) | (II-6) | (III-2) |
| M-79 | (I-3) | (II-1) | (III-2) |
| M-80 | (I-3) | (II-2) | (III-2) |
| M-81 | (I-3) | (II-3) | (III-2) |
| M-82 | (I-3) | (II-4) | (III-2) |
| M-83 | (I-3) | (II-5) | (III-2) |
| M-84 | (I-3) | (II-6) | (III-2) |
| M-85 | (I-4) | (II-1) | (III-2) |
| M-86 | (I-4) | (II-2) | (III-2) |
| M-87 | (I-4) | (II-3) | (III-2) |
| M-88 | (I-4) | (II-4) | (III-2) |
| M-89 | (I-4) | (II-5) | (III-2) |
| M-90 | (I-4) | (II-6) | (III-2) |
| M-91 | (I-5) | (II-1) | (III-2) |
| M-92 | (I-5) | (II-2) | (III-2) |
| M-93 | (I-5) | (II-3) | (III-2) |
| M-94 | (I-5) | (II-4) | (III-2) |
| M-95 | (I-5) | (II-5) | (III-2) |
| M-96 | (I-5) | (II-6) | (III-2) |
| M-97 | (I-6) | (II-1) | (III-2) |
| M-98 | (I-6) | (II-2) | (III-2) |
| M-99 | (I-6) | (II-3) | (III-2) |
| M-100 | (I-6) | (II-4) | (III-2) |
| M-101 | (I-6) | (II-5) | (III-2) |
| M-102 | (I-6) | (II-6) | (III-2) |
| M-103 | (I-7) | (II-1) | (III-2) |
| M-104 | (I-7) | (II-2) | (III-2) |
| M-105 | (I-7) | (II-3) | (III-2) |
| M-106 | (I-7) | (II-4) | (III-2) |
| M-107 | (I-7) | (II-5) | (III-2) |
| M-108 | (I-7) | (II-6) | (III-2) |
| M-109 | (I-8) | (II-1) | (III-2) |
| M-110 | (I-8) | (II-2) | (III-2) |
| M-111 | (I-8) | (II-3) | (III-2) |
| M-112 | (I-8) | (II-4) | (III-2) |
| M-113 | (I-8) | (II-5) | (III-2) |
| M-114 | (I-8) | (II-6) | (III-2) |
| M-115 | (I-9) | (II-1) | (III-2) |
| M-116 | (I-9) | (II-2) | (III-2) |
| M-117 | (I-9) | (II-3) | (III-2) |
| M-118 | (I-9) | (II-4) | (III-2) |
| M-119 | (I-9) | (II-5) | (III-2) |
| M-120 | (I-9) | (II-6) | (III-2) |
| M-121 | (I-10) | (II-1) | (III-2) |
| M-122 | (I-10) | (II-2) | (III-2) |
| M-123 | (I-10) | (II-3) | (III-2) |
| M-124 | (I-10) | (II-4) | (III-2) |
| M-125 | (I-10) | (II-5) | (III-2) |
| M-126 | (I-10) | (II-6) | (III-2) |
| M-127 | (I-11) | (II-1) | (III-2) |
| M-128 | (I-11) | (II-2) | (III-2) |
| M-129 | (I-11) | (II-3) | (III-2) |
| M-130 | (I-11) | (II-4) | (III-2) |
| M-131 | (I-11) | (II-5) | (III-2) |
| M-132 | (I-11) | (II-6) | (III-2) |

Within the present invention, the ternary mixtures M-1, M-2, M-3, M-4, M-5, M-6, M-7, M-8, M-9, M-10, M-11, M-12, M-49, M-50, M-51, M-52, M-53, M-54, M-61, M-62, M-63, M-64, M-65, M-66, M-67, M-68, M-69, M-70, M-71, M-72, M-73, M-74, M-75, M-76, M-77, M-78, M-115, M-116, M-117, M-118, M-119, M-120, M-127, M-128, M-129, M-130, M-131 and M-132 are preferred. The mixtures M-1, M-2, M-3, M-4, M-5, M-6, M-8, M-9, M-10, M-12, M-50, M-51, M-52, M-54, M-62, M-63, M-64, M-66, M-67, M-68, M-69, M-70, M-71, M-72, M-74, M-75, M-116, M-117, M-128 and M-129 are more preferred and the mixtures M-2, M-3, M-4, M-6, M-68, M-69, M-70 and M-72 are most preferred. The mixtures M-2, M-3, M-4, M-6, M-69 and M-70 are utmost preferred.

Within the methods of the invention, in particular the method for synergistically increasing the health of a plant, the following mixtures are preferred: M-1, M-2, M-3, M-4, M-5, M-6, M-7, M-8, M-9, M-10, M-11, M-12, M-49, M-50, M-51, M-52, M-53, M-54, M-61, M-62, M-63, M-64, M-65, M-66, M-67, M-68, M-69, M-70, M-71, M-72, M-73, M-74, M-75, M-76, M-77, M-78, M-115, M-116, M-117, M-118, M-119, M-120, M-127, M-128, M-129, M-130, M-131 and M-132. The mixtures M-1, M-2, M-3, M-4, M-5, M-6, M-8, M-9, M-10, M-12, M-50, M-51, M-52, M-54, M-62, M-63, M-64, M-66, M-67, M-68, M-69, M-70, M-71, M-72, M-74, M-75, M-116, M-117, M-128 and M-129 are more preferred and the mixtures M-2, M-3, M-4, M-6, M-68, M-69, M-70 and M-72 are most preferred. The mixtures M-2, M-3, M-4, M-6, M-69 and M-70 are utmost preferred.

When used for synergistically increasing the health of a plant according to the invention, the following mixtures are preferred: M-1, M-2, M-3, M-4, M-5, M-6, M-7, M-8, M-9, M-10, M-11, M-12, M-49, M-50, M-51, M-52, M-53, M-54, M-61, M-62, M-63, M-64, M-65, M-66, M-67, M-68, M-69, M-70, M-71, M-72, M-73, M-74, M-75, M-76, M-77, M-78, M-115, M-116, M-117, M-118, M-119, M-120, M-127, M-128, M-129, M-130, M-131 and M-132. The mixtures M-1, M-2, M-3, M-4, M-5, M-6, M-8, M-9, M-10, M-12, M-50, M-51, M-52, M-54, M-62, M-63, M-64, M-66, M-67, M-68, M-69, M-70, M-71, M-72, M-74, M-75, M-116, M-117, M-128 and M-129 are more preferred and the mixtures M-2, M-3, M-4, M-6, M-68, M-69, M-70 and M-72 are most preferred. The mixtures M-2, M-3, M-4, M-6, M-69 and M-70 are utmost preferred.

Preferred mixtures according to the invention comprise as active compound a fungicidal compound (I) selected from the group of strobilurins consisting of pyraclostrobin, azoxystrobin, dimoxystrobin, enestroburin, fluoxastrobin, kresoxim-methyl, metominostrobin, orysastrobin, picoxystrobin, pyribencarb and trifloxystrobin.

More preferred mixtures according to the invention comprise as active compound a fungicidal compound (I) selected from the group of strobilurins consisting of pyraclostrobin, azoxystrobin, picoxystrobin and trifloxystrobin.

Most preferred mixtures according to the invention comprise pyraclostrobin as active compound (I).

In a preferred embodiment, the mixtures according to the invention comprise as active compound at least one herbicidal compound (II) selected from the group of imidazolinones consisting of imazapic, imazapyr, imazethapyr and imazamox.

Preferred mixtures according to the invention comprise as active compound at least one herbicidal compound (II) selected from the group of imidazolinones consisting of imazethapyr, imazamox and imazaquin.

More preferred mixtures according to the invention comprise as active compound at least one herbicidal compound (II) selected from the group of imidazolinones consisting of imazethapyr and imazamox.

Especially preferred mixtures according to the invention comprise as active compound at least one herbicidal compound (II) selected from the group of imidazolinones consisting of imazapic and imazapyr.

Preferred mixtures according to the invention comprise glyphosate or an agriculturally acceptable salt thereof as a second herbicidal compound (III).

In one embodiment, the mixture as defined above, additionally comprises a second fungicide (compound IV) selected from the groups consisting of:

A) Strobilurines:

pyraclostrobin (IV-A-1), azoxystrobin (IV-A-2), dimoxystrobin (IV-A-3), enestroburin (IV-A-4), fluoxastrobin (IV-A-5), kresoxim-methyl (IV-A-6), metominostrobin (IV-A-7), orysastrobin (IV-A-8), picoxystrobin (IV-A-9), pyribencarb (IV-A-10), trifloxystrobin (IV-A-11), pyrametostrobin (IV-A-12), pyraoxystrobin (IV-A-13), coumoxystrobin (IV-A-14), coumethoxystrobin (IV-A-15), triclopyricarb (=chlorodincarb) (IV-A-16), fenaminostrobin (=diclofenoxystrobin) (IV-A-17), flufenoxystrobin (IV-A-18), 2-(2-(6-(3-chloro-2-methyl-phenoxy)-5-fluoro-pyrimidin-4-yloxy)-phenyl)-2-methoxyimino-N-methyl-acetamide (IV-A-19), 3-methoxy-2-(2-(N-(4-methoxy-phenyl)-cyclopropane-carboximidoylsulfanyl-methyl)-phenyl)-acrylic acid methyl ester (IV-A-20), methyl (2-chloro-5-[1-(3-methyl-benzyloxyimino)ethyl]benzyl)carbamate (IV-A-21) and 2-(2-(3-(2,6-dichlorophenyl)-1-methyl-allylideneaminooxymethyl)-phenyl)-2-methoxyimino-N methyl-acetamide (IV-A-22); and

B) Carboxamides:

benodanil (IV-B-1), bixafen (IV-B-2), boscalid (IV-B-3), carboxin (IV-B-4), fenfuram (IV-B-5), flutolanil (IV-B-6), fluxapyroxad (IV-B-7), furametpyr (IV-B-8), isopyrazam (IV-B9), mepronil (IV-B-10), oxycarboxin (IV-B-11), penflufen (IV-B-12), penthiopyrad (IV-B-13), sedaxane (IV-B-14), thifluzamide (IV-B-15), N-(4′-trifluoro-methylthiobiphenyl-2-yl)-3 difluoromethyl-1-methyl-1H pyrazole-4-carboxamide (IV-B-16), N-(2-(1,3,3-trimethylbutyl)-phenyl)-1,3-dimethyl-5 fluoro-1H-pyrazole-4 carboxamide (IV-B-17) and fluopyram (IV-B-18).

Preferred mixtures according to the invention comprise a second fungicide (compound IV) selected from the group of strobilurins consisting of pyraclostrobin, azoxystrobin, dimoxystrobin, enestroburin, fluoxastrobin, kresoxim-methyl, metominostrobin, orysastrobin, picoxystrobin, pyribencarb and trifloxystrobin.

More preferred mixtures according to the invention comprise a second fungicide (compound IV) selected from the group of strobilurins consisting of pyraclostrobin, azoxystrobin, picoxystrobin and trifloxystrobin.

Most preferred mixtures according to the invention comprise pyraclostrobin as active compound (IV).

In a preferred embodiment, the mixtures according to the invention comprise a second fungicide (compound IV) selected from the group of carboxamides consisting of bixafen, boscalid, fluopyram, isopyrazam, penflufen, penthiopyrad, sedaxane and fluxapyroxad.

In a more preferred embodiment, the mixtures according to the invention comprise a second fungicide (compound IV) selected from the group of carboxamides consisting of fluxapyroxad, penthiopyrad, bixafen and isopyrazam.

In a most preferred embodiment, the mixtures according to the invention comprise fluxapyroxad as active compound (IV).

Within table 2, the following abbreviations are used: No. is the number of the respective mixture; (I) is compound (I); (II) is compound (II); (III) is compound (III) and (IV) is compound (IV) as defined above.

TABLE 2

| No. | (I) | (II) | (III) | (IV) |
|---|---|---|---|---|
| T-1 | (I-1) | (II-1) | (III-1) | (IV-B-2) |
| T-2 | (I-1) | (II-2) | (III-1) | (IV-B-2) |
| T-3 | (I-1) | (II-3) | (III-1) | (IV-B-2) |
| T-4 | (I-1) | (II-4) | (III-1) | (IV-B-2) |
| T-5 | (I-1) | (II-5) | (III-1) | (IV-B-2) |
| T-6 | (I-1) | (II-6) | (III-1) | (IV-B-2) |
| T-7 | (I-2) | (II-1) | (III-1) | (IV-B-2) |
| T-8 | (I-2) | (II-2) | (III-1) | (IV-B-2) |
| T-9 | (I-2) | (II-3) | (III-1) | (IV-B-2) |
| T-10 | (I-2) | (II-4) | (III-1) | (IV-B-2) |
| T-11 | (I-2) | (II-5) | (III-1) | (IV-B-2) |
| T-12 | (I-2) | (II-6) | (III-1) | (IV-B-2) |
| T-13 | (I-3) | (II-1) | (III-1) | (IV-B-2) |
| T-14 | (I-3) | (II-2) | (III-1) | (IV-B-2) |
| T-15 | (I-3) | (II-3) | (III-1) | (IV-B-2) |
| T-16 | (I-3) | (II-4) | (III-1) | (IV-B-2) |
| T-17 | (I-3) | (II-5) | (III-1) | (IV-B-2) |
| T-18 | (I-3) | (II-6) | (III-1) | (IV-B-2) |
| T-19 | (I-5) | (II-1) | (III-1) | (IV-B-2) |
| T-20 | (I-5) | (II-2) | (III-1) | (IV-B-2) |
| T-21 | (I-5) | (II-3) | (III-1) | (IV-B-2) |
| T-22 | (I-5) | (II-4) | (III-1) | (IV-B-2) |
| T-23 | (I-5) | (II-5) | (III-1) | (IV-B-2) |
| T-24 | (I-5) | (II-6) | (III-1) | (IV-B-2) |
| T-25 | (I-6) | (II-1) | (III-1) | (IV-B-2) |
| T-26 | (I-6) | (II-2) | (III-1) | (IV-B-2) |
| T-27 | (I-6) | (II-3) | (III-1) | (IV-B-2) |
| T-28 | (I-6) | (II-4) | (III-1) | (IV-B-2) |
| T-29 | (I-6) | (II-5) | (III-1) | (IV-B-2) |
| T-30 | (I-6) | (II-6) | (III-1) | (IV-B-2) |
| T-31 | (I-9) | (II-1) | (III-1) | (IV-B-2) |
| T-32 | (I-9) | (II-2) | (III-1) | (IV-B-2) |
| T-33 | (I-9) | (II-3) | (III-1) | (IV-B-2) |
| T-34 | (I-9) | (II-4) | (III-1) | (IV-B-2) |
| T-35 | (I-9) | (II-5) | (III-1) | (IV-B-2) |
| T-36 | (I-9) | (II-6) | (III-1) | (IV-B-2) |
| T-37 | (I-11) | (II-1) | (III-1) | (IV-B-2) |
| T-38 | (I-11) | (II-2) | (III-1) | (IV-B-2) |
| T-39 | (I-11) | (II-3) | (III-1) | (IV-B-2) |
| T-40 | (I-11) | (II-4) | (III-1) | (IV-B-2) |
| T-41 | (I-11) | (II-5) | (III-1) | (IV-B-2) |
| T-42 | (I-11) | (II-6) | (III-1) | (IV-B-2) |
| T-43 | (I-1) | (II-1) | (III-2) | (IV-B-2) |
| T-44 | (I-1) | (II-2) | (III-2) | (IV-B-2) |
| T-45 | (I-1) | (II-3) | (III-2) | (IV-B-2) |
| T-46 | (I-1) | (II-4) | (III-2) | (IV-B-2) |
| T-47 | (I-1) | (II-5) | (III-2) | (IV-B-2) |
| T-48 | (I-1) | (II-6) | (III-2) | (IV-B-2) |
| T-49 | (I-2) | (II-1) | (III-2) | (IV-B-2) |
| T-50 | (I-2) | (II-2) | (III-2) | (IV-B-2) |
| T-51 | (I-2) | (II-3) | (III-2) | (IV-B-2) |
| T-52 | (I-2) | (II-4) | (III-2) | (IV-B-2) |
| T-53 | (I-2) | (II-5) | (III-2) | (IV-B-2) |
| T-54 | (I-2) | (II-6) | (III-2) | (IV-B-2) |
| T-55 | (I-3) | (II-1) | (III-2) | (IV-B-2) |
| T-56 | (I-3) | (II-2) | (III-2) | (IV-B-2) |
| T-57 | (I-3) | (II-3) | (III-2) | (IV-B-2) |
| T-58 | (I-3) | (II-4) | (III-2) | (IV-B-2) |
| T-59 | (I-3) | (II-5) | (III-2) | (IV-B-2) |
| T-60 | (I-3) | (II-6) | (III-2) | (IV-B-2) |
| T-61 | (I-5) | (II-1) | (III-2) | (IV-B-2) |
| T-62 | (I-5) | (II-2) | (III-2) | (IV-B-2) |
| T-63 | (I-5) | (II-3) | (III-2) | (IV-B-2) |
| T-64 | (I-5) | (II-4) | (III-2) | (IV-B-2) |
| T-65 | (I-5) | (II-5) | (III-2) | (IV-B-2) |
| T-66 | (I-5) | (II-6) | (III-2) | (IV-B-2) |
| T-67 | (I-6) | (II-1) | (III-2) | (IV-B-2) |
| T-68 | (I-6) | (II-2) | (III-2) | (IV-B-2) |
| T-69 | (I-6) | (II-3) | (III-2) | (IV-B-2) |
| T-70 | (I-6) | (II-4) | (III-2) | (IV-B-2) |
| T-71 | (I-6) | (II-5) | (III-2) | (IV-B-2) |
| T-72 | (I-6) | (II-6) | (III-2) | (IV-B-2) |
| T-73 | (I-9) | (II-1) | (III-2) | (IV-B-2) |
| T-74 | (I-9) | (II-2) | (III-2) | (IV-B-2) |
| T-75 | (I-9) | (II-3) | (III-2) | (IV-B-2) |
| T-76 | (I-9) | (II-4) | (III-2) | (IV-B-2) |
| T-77 | (I-9) | (II-5) | (III-2) | (IV-B-2) |
| T-78 | (I-9) | (II-6) | (III-2) | (IV-B-2) |
| T-79 | (I-11) | (II-1) | (III-2) | (IV-B-2) |
| T-80 | (I-11) | (II-2) | (III-2) | (IV-B-2) |
| T-81 | (I-11) | (II-3) | (III-2) | (IV-B-2) |
| T-82 | (I-11) | (II-4) | (III-2) | (IV-B-2) |
| T-83 | (I-11) | (II-5) | (III-2) | (IV-B-2) |
| T-84 | (I-11) | (II-6) | (III-2) | (IV-B-2) |
| T-85 | (I-1) | (II-1) | (III-1) | (IV-B-7) |
| T-86 | (I-1) | (II-2) | (III-1) | (IV-B-7) |
| T-87 | (I-1) | (II-3) | (III-1) | (IV-B-7) |
| T-88 | (I-1) | (II-4) | (III-1) | (IV-B-7) |
| T-89 | (I-1) | (II-5) | (III-1) | (IV-B-7) |
| T-90 | (I-1) | (II-6) | (III-1) | (IV-B-7) |
| T-91 | (I-2) | (II-1) | (III-1) | (IV-B-7) |
| T-92 | (I-2) | (II-2) | (III-1) | (IV-B-7) |
| T-93 | (I-2) | (II-3) | (III-1) | (IV-B-7) |
| T-94 | (I-2) | (II-4) | (III-1) | (IV-B-7) |
| T-95 | (I-2) | (II-5) | (III-1) | (IV-B-7) |
| T-96 | (I-2) | (II-6) | (III-1) | (IV-B-7) |
| T-97 | (I-3) | (II-1) | (III-1) | (IV-B-7) |
| T-98 | (I-3) | (II-2) | (III-1) | (IV-B-7) |
| T-99 | (I-3) | (II-3) | (III-1) | (IV-B-7) |
| T-100 | (I-3) | (II-4) | (III-1) | (IV-B-7) |
| T-101 | (I-3) | (II-5) | (III-1) | (IV-B-7) |
| T-102 | (I-3) | (II-6) | (III-1) | (IV-B-7) |
| T-103 | (I-5) | (II-1) | (III-1) | (IV-B-7) |
| T-104 | (I-5) | (II-2) | (III-1) | (IV-B-7) |
| T-105 | (I-5) | (II-3) | (III-1) | (IV-B-7) |
| T-106 | (I-5) | (II-4) | (III-1) | (IV-B-7) |
| T-107 | (I-5) | (II-5) | (III-1) | (IV-B-7) |
| T-108 | (I-5) | (II-6) | (III-1) | (IV-B-7) |
| T-109 | (I-6) | (II-1) | (III-1) | (IV-B-7) |
| T-110 | (I-6) | (II-2) | (III-1) | (IV-B-7) |
| T-111 | (I-6) | (II-3) | (III-1) | (IV-B-7) |
| T-112 | (I-6) | (II-4) | (III-1) | (IV-B-7) |
| T-113 | (I-6) | (II-5) | (III-1) | (IV-B-7) |
| T-114 | (I-6) | (II-6) | (III-1) | (IV-B-7) |
| T-115 | (I-9) | (II-1) | (III-1) | (IV-B-7) |
| T-116 | (I-9) | (II-2) | (III-1) | (IV-B-7) |
| T-117 | (I-9) | (II-3) | (III-1) | (IV-B-7) |
| T-118 | (I-9) | (II-4) | (III-1) | (IV-B-7) |
| T-119 | (I-9) | (II-5) | (III-1) | (IV-B-7) |
| T-120 | (I-9) | (II-6) | (III-1) | (IV-B-7) |
| T-121 | (I-11) | (II-1) | (III-1) | (IV-B-7) |
| T-122 | (I-11) | (II-2) | (III-1) | (IV-B-7) |
| T-123 | (I-11) | (II-3) | (III-1) | (IV-B-7) |
| T-124 | (I-11) | (II-4) | (III-1) | (IV-B-7) |
| T-125 | (I-11) | (II-5) | (III-1) | (IV-B-7) |
| T-126 | (I-11) | (II-6) | (III-1) | (IV-B-7) |
| T-127 | (I-1) | (II-1) | (III-2) | (IV-B-7) |
| T-128 | (I-1) | (II-2) | (III-2) | (IV-B-7) |
| T-129 | (I-1) | (II-3) | (III-2) | (IV-B-7) |
| T-130 | (I-1) | (II-4) | (III-2) | (IV-B-7) |
| T-131 | (I-1) | (II-5) | (III-2) | (IV-B-7) |
| T-132 | (I-1) | (II-6) | (III-2) | (IV-B-7) |
| T-133 | (I-2) | (II-1) | (III-2) | (IV-B-7) |
| T-134 | (I-2) | (II-2) | (III-2) | (IV-B-7) |
| T-135 | (I-2) | (II-3) | (III-2) | (IV-B-7) |
| T-136 | (I-2) | (II-4) | (III-2) | (IV-B-7) |
| T-137 | (I-2) | (II-5) | (III-2) | (IV-B-7) |
| T-138 | (I-2) | (II-6) | (III-2) | (IV-B-7) |
| T-139 | (I-3) | (II-1) | (III-2) | (IV-B-7) |
| T-140 | (I-3) | (II-2) | (III-2) | (IV-B-7) |
| T-141 | (I-3) | (II-3) | (III-2) | (IV-B-7) |
| T-142 | (I-3) | (II-4) | (III-2) | (IV-B-7) |
| T-143 | (I-3) | (II-5) | (III-2) | (IV-B-7) |
| T-145 | (I-5) | (II-1) | (III-2) | (IV-B-7) |
| T-146 | (I-5) | (II-2) | (III-2) | (IV-B-7) |
| T-147 | (I-5) | (II-3) | (III-2) | (IV-B-7) |
| T-148 | (I-5) | (II-4) | (III-2) | (IV-B-7) |
| T-149 | (I-5) | (II-5) | (III-2) | (IV-B-7) |
| T-150 | (I-5) | (II-6) | (III-2) | (IV-B-7) |
| T-151 | (I-6) | (II-1) | (III-2) | (IV-B-7) |
| T-152 | (I-6) | (II-2) | (III-2) | (IV-B-7) |
| T-153 | (I-6) | (II-3) | (III-2) | (IV-B-7) |
| T-154 | (I-6) | (II-4) | (III-2) | (IV-B-7) |
| T-155 | (I-6) | (II-5) | (III-2) | (IV-B-7) |
| T-156 | (I-6) | (II-6) | (III-2) | (IV-B-7) |
| T-157 | (I-9) | (II-1) | (III-2) | (IV-B-7) |
| T-158 | (I-9) | (II-2) | (III-2) | (IV-B-7) |
| T-159 | (I-9) | (II-3) | (III-2) | (IV-B-7) |
| T-160 | (I-9) | (II-4) | (III-2) | (IV-B-7) |
| T-161 | (I-9) | (II-5) | (III-2) | (IV-B-7) |
| T-162 | (I-9) | (II-6) | (III-2) | (IV-B-7) |
| T-163 | (I-11) | (II-1) | (III-2) | (IV-B-7) |
| T-164 | (I-11) | (II-2) | (III-2) | (IV-B-7) |
| T-165 | (I-11) | (II-3) | (III-2) | (IV-B-7) |
| T-166 | (I-11) | (II-4) | (III-2) | (IV-B-7) |
| T-167 | (I-11) | (II-5) | (III-2) | (IV-B-9) |
| T-168 | (I-11) | (II-6) | (III-2) | (IV-B-9) |
| T-169 | (I-1) | (II-1) | (III-1) | (IV-B-9) |
| T-170 | (I-1) | (II-2) | (III-1) | (IV-B-9) |
| T-171 | (I-1) | (II-3) | (III-1) | (IV-B-9) |
| T-172 | (I-1) | (II-4) | (III-1) | (IV-B-9) |
| T-173 | (I-1) | (II-5) | (III-1) | (IV-B-9) |
| T-174 | (I-1) | (II-6) | (III-1) | (IV-B-9) |
| T-175 | (I-2) | (II-1) | (III-1) | (IV-B-9) |
| T-176 | (I-2) | (II-2) | (III-1) | (IV-B-9) |
| T-177 | (I-2) | (II-3) | (III-1) | (IV-B-9) |
| T-178 | (I-2) | (II-4) | (III-1) | (IV-B-9) |
| T-179 | (I-2) | (II-5) | (III-1) | (IV-B-9) |
| T-180 | (I-2) | (II-6) | (III-1) | (IV-B-9) |
| T-181 | (I-3) | (II-1) | (III-1) | (IV-B-9) |
| T-182 | (I-3) | (II-2) | (III-1) | (IV-B-9) |
| T-183 | (I-3) | (II-3) | (III-1) | (IV-B-9) |
| T-184 | (I-3) | (II-4) | (III-1) | (IV-B-9) |
| T-185 | (I-3) | (II-5) | (III-1) | (IV-B-9) |
| T-186 | (I-3) | (II-6) | (III-1) | (IV-B-9) |
| T-187 | (I-5) | (II-1) | (III-1) | (IV-B-9) |
| T-188 | (I-5) | (II-2) | (III-1) | (IV-B-9) |
| T-189 | (I-5) | (II-3) | (III-1) | (IV-B-9) |
| T-190 | (I-5) | (II-4) | (III-1) | (IV-B-9) |
| T-191 | (I-5) | (II-5) | (III-1) | (IV-B-9) |
| T-192 | (I-5) | (II-6) | (III-1) | (IV-B-9) |
| T-193 | (I-6) | (II-1) | (III-1) | (IV-B-9) |
| T-194 | (I-6) | (II-2) | (III-1) | (IV-B-9) |
| T-195 | (I-6) | (II-3) | (III-1) | (IV-B-9) |
| T-196 | (I-6) | (II-4) | (III-1) | (IV-B-9) |
| T-197 | (I-6) | (II-5) | (III-1) | (IV-B-9) |
| T-198 | (I-6) | (II-6) | (III-1) | (IV-B-9) |
| T-199 | (I-9) | (II-1) | (III-1) | (IV-B-9) |
| T-200 | (I-9) | (II-2) | (III-1) | (IV-B-9) |
| T-201 | (I-9) | (II-3) | (III-1) | (IV-B-9) |
| T-202 | (I-9) | (II-4) | (III-1) | (IV-B-9) |
| T-203 | (I-9) | (II-5) | (III-1) | (IV-B-9) |
| T-204 | (I-9) | (II-6) | (III-1) | (IV-B-9) |
| T-205 | (I-11) | (II-1) | (III-1) | (IV-B-9) |
| T-206 | (I-11) | (II-2) | (III-1) | (IV-B-9) |
| T-207 | (I-11) | (II-3) | (III-1) | (IV-B-9) |
| T-208 | (I-11) | (II-4) | (III-1) | (IV-B-9) |
| T-209 | (I-11) | (II-5) | (III-1) | (IV-B-9) |
| T-210 | (I-11) | (II-6) | (III-1) | (IV-B-9) |
| T-211 | (I-1) | (II-1) | (III-2) | (IV-B-9) |
| T-212 | (I-1) | (II-2) | (III-2) | (IV-B-9) |
| T-213 | (I-1) | (II-3) | (III-2) | (IV-B-9) |
| T-214 | (I-1) | (II-4) | (III-2) | (IV-B-9) |
| T-215 | (I-1) | (II-5) | (III-2) | (IV-B-9) |
| T-216 | (I-1) | (II-6) | (III-2) | (IV-B-9) |
| T-217 | (I-2) | (II-1) | (III-2) | (IV-B-9) |
| T-218 | (I-2) | (II-2) | (III-2) | (IV-B-9) |
| T-219 | (I-2) | (II-3) | (III-2) | (IV-B-9) |
| T-220 | (I-2) | (II-4) | (III-2) | (IV-B-9) |
| T-221 | (I-2) | (II-5) | (III-2) | (IV-B-9) |
| T-222 | (I-2) | (II-6) | (III-2) | (IV-B-9) |
| T-223 | (I-3) | (II-1) | (III-2) | (IV-B-9) |
| T-224 | (I-3) | (II-2) | (III-2) | (IV-B-9) |
| T-225 | (I-3) | (II-3) | (III-2) | (IV-B-9) |
| T-226 | (I-3) | (II-4) | (III-2) | (IV-B-9) |
| T-227 | (I-3) | (II-5) | (III-2) | (IV-B-9) |
| T-228 | (I-3) | (II-6) | (III-2) | (IV-B-9) |
| T-229 | (I-5) | (II-1) | (III-2) | (IV-B-9) |
| T-230 | (I-5) | (II-2) | (III-2) | (IV-B-9) |
| T-231 | (I-5) | (II-3) | (III-2) | (IV-B-9) |
| T-232 | (I-5) | (II-4) | (III-2) | (IV-B-9) |
| T-233 | (I-5) | (II-5) | (III-2) | (IV-B-9) |
| T-234 | (I-5) | (II-6) | (III-2) | (IV-B-9) |
| T-235 | (I-6) | (II-1) | (III-2) | (IV-B-9) |
| T-236 | (I-6) | (II-2) | (III-2) | (IV-B-9) |
| T-237 | (I-6) | (II-3) | (III-2) | (IV-B-9) |
| T-238 | (I-6) | (II-4) | (III-2) | (IV-B-9) |
| T-239 | (I-6) | (II-5) | (III-2) | (IV-B-9) |
| T-240 | (I-6) | (II-6) | (III-2) | (IV-B-9) |
| T-241 | (I-9) | (II-1) | (III-2) | (IV-B-9) |
| T-242 | (I-9) | (II-2) | (III-2) | (IV-B-9) |
| T-243 | (I-9) | (II-3) | (III-2) | (IV-B-9) |
| T-244 | (I-9) | (II-4) | (III-2) | (IV-B-9) |
| T-245 | (I-9) | (II-5) | (III-2) | (IV-B-9) |
| T-246 | (I-9) | (II-6) | (III-2) | (IV-B-9) |
| T-247 | (I-11) | (II-1) | (III-2) | (IV-B-9) |
| T-248 | (I-11) | (II-2) | (III-2) | (IV-B-9) |
| T-249 | (I-11) | (II-3) | (III-2) | (IV-B-9) |
| T-250 | (I-11) | (II-4) | (III-2) | (IV-B-9) |
| T-251 | (I-11) | (II-5) | (III-2) | (IV-B-9) |
| T-252 | (I-11) | (II-6) | (III-2) | (IV-B-9) |
| T-253 | (I-11) | (II-5) | (III-2) | (IV-B-13) |
| T-254 | (I-11) | (II-6) | (III-2) | (IV-B-13) |
| T-255 | (I-1) | (II-1) | (III-1) | (IV-B-13) |
| T-256 | (I-1) | (II-2) | (III-1) | (IV-B-13) |
| T-257 | (I-1) | (II-3) | (III-1) | (IV-B-13) |
| T-258 | (I-1) | (II-4) | (III-1) | (IV-B-13) |
| T-259 | (I-1) | (II-5) | (III-1) | (IV-B-13) |
| T-260 | (I-1) | (II-6) | (III-1) | (IV-B-13) |
| T-261 | (I-2) | (II-1) | (III-1) | (IV-B-13) |
| T-262 | (I-2) | (II-2) | (III-1) | (IV-B-13) |
| T-263 | (I-2) | (II-3) | (III-1) | (IV-B-13) |
| T-264 | (I-2) | (II-4) | (III-1) | (IV-B-13) |
| T-265 | (I-2) | (II-5) | (III-1) | (IV-B-13) |
| T-266 | (I-2) | (II-6) | (III-1) | (IV-B-13) |
| T-267 | (I-3) | (II-1) | (III-1) | (IV-B-13) |
| T-268 | (I-3) | (II-2) | (III-1) | (IV-B-13) |
| T-269 | (I-3) | (II-3) | (III-1) | (IV-B-13) |
| T-270 | (I-3) | (II-4) | (III-1) | (IV-B-13) |
| T-271 | (I-3) | (II-5) | (III-1) | (IV-B-13) |
| T-272 | (I-3) | (II-6) | (III-1) | (IV-B-13) |
| T-273 | (I-5) | (II-1) | (III-1) | (IV-B-13) |
| T-274 | (I-5) | (II-2) | (III-1) | (IV-B-13) |
| T-275 | (I-5) | (II-3) | (III-1) | (IV-B-13) |
| T-276 | (I-5) | (II-4) | (III-1) | (IV-B-13) |
| T-277 | (I-5) | (II-5) | (III-1) | (IV-B-13) |
| T-278 | (I-5) | (II-6) | (III-1) | (IV-B-13) |
| T-279 | (I-6) | (II-1) | (III-1) | (IV-B-13) |
| T-280 | (I-6) | (II-2) | (III-1) | (IV-B-13) |
| T-281 | (I-6) | (II-3) | (III-1) | (IV-B-13) |
| T-282 | (I-6) | (II-4) | (III-1) | (IV-B-13) |
| T-283 | (I-6) | (II-5) | (III-1) | (IV-B-13) |
| T-284 | (I-6) | (II-6) | (III-1) | (IV-B-13) |
| T-285 | (I-9) | (II-1) | (III-1) | (IV-B-13) |
| T-286 | (I-9) | (II-2) | (III-1) | (IV-B-13) |
| T-287 | (I-9) | (II-3) | (III-1) | (IV-B-13) |
| T-288 | (I-9) | (II-4) | (III-1) | (IV-B-13) |
| T-289 | (I-9) | (II-5) | (III-1) | (IV-B-13) |
| T-290 | (I-9) | (II-6) | (III-1) | (IV-B-13) |
| T-291 | (I-11) | (II-1) | (III-1) | (IV-B-13) |
| T-292 | (I-11) | (II-2) | (III-1) | (IV-B-13) |
| T-293 | (I-11) | (II-3) | (III-1) | (IV-B-13) |
| T-294 | (I-11) | (II-4) | (III-1) | (IV-B-13) |
| T-295 | (I-11) | (II-5) | (III-1) | (IV-B-13) |
| T-296 | (I-11) | (II-6) | (III-1) | (IV-B-13) |
| T-297 | (I-1) | (II-1) | (III-2) | (IV-B-13) |
| T-298 | (I-1) | (II-2) | (III-2) | (IV-B-13) |
| T-299 | (I-1) | (II-3) | (III-2) | (IV-B-13) |
| T-300 | (I-1) | (II-4) | (III-2) | (IV-B-13) |
| T-301 | (I-1) | (II-5) | (III-2) | (IV-B-13) |
| T-302 | (I-1) | (II-6) | (III-2) | (IV-B-13) |
| T-303 | (I-2) | (II-1) | (III-2) | (IV-B-13) |
| T-304 | (I-2) | (II-2) | (III-2) | (IV-B-13) |
| T-305 | (I-2) | (II-3) | (III-2) | (IV-B-13) |
| T-306 | (I-2) | (II-4) | (III-2) | (IV-B-13) |
| T-307 | (I-2) | (II-5) | (III-2) | (IV-B-13) |
| T-308 | (I-2) | (II-6) | (III-2) | (IV-B-13) |
| T-309 | (I-3) | (II-1) | (III-2) | (IV-B-13) |
| T-310 | (I-3) | (II-2) | (III-2) | (IV-B-13) |
| T-311 | (I-3) | (II-3) | (III-2) | (IV-B-13) |
| T-312 | (I-3) | (II-4) | (III-2) | (IV-B-13) |
| T-313 | (I-3) | (II-5) | (III-2) | (IV-B-13) |
| T-314 | (I-3) | (II-6) | (III-2) | (IV-B-13) |
| T-315 | (I-5) | (II-1) | (III-2) | (IV-B-13) |
| T-316 | (I-5) | (II-2) | (III-2) | (IV-B-13) |
| T-317 | (I-5) | (II-3) | (III-2) | (IV-B-13) |
| T-318 | (I-5) | (II-4) | (III-2) | (IV-B-13) |
| T-319 | (I-5) | (II-5) | (III-2) | (IV-B-13) |
| T-320 | (I-5) | (II-6) | (III-2) | (IV-B-13) |
| T-321 | (I-6) | (II-1) | (III-2) | (IV-B-13) |
| T-322 | (I-6) | (II-2) | (III-2) | (IV-B-13) |
| T-323 | (I-6) | (II-3) | (III-2) | (IV-B-13) |
| T-324 | (I-6) | (II-4) | (III-2) | (IV-B-13) |
| T-325 | (I-6) | (II-5) | (III-2) | (IV-B-13) |
| T-326 | (I-6) | (II-6) | (III-2) | (IV-B-13) |
| T-327 | (I-9) | (II-1) | (III-2) | (IV-B-13) |
| T-328 | (I-9) | (II-2) | (III-2) | (IV-B-13) |
| T-329 | (I-9) | (II-3) | (III-2) | (IV-B-13) |
| T-330 | (I-9) | (II-4) | (III-2) | (IV-B-13) |
| T-331 | (I-9) | (II-5) | (III-2) | (IV-B-13) |
| T-332 | (I-9) | (II-6) | (III-2) | (IV-B-13) |
| T-333 | (I-11) | (II-1) | (III-2) | (IV-B-13) |
| T-334 | (I-11) | (II-2) | (III-2) | (IV-B-13) |
| T-335 | (I-11) | (II-3) | (III-2) | (IV-B-13) |
| T-336 | (I-11) | (II-4) | (III-2) | (IV-B-13) |
| T-337 | (I-11) | (II-5) | (III-2) | (IV-B-13) |
| T-338 | (I-11) | (II-6) | (III-2) | (IV-B-13) |

Within the present invention, the quaternary mixtures T-1, T-2, T-3, T-4, T-5, T-6, T-7, T-8, T-9, T-10, T-11, T-12, T-37, T-38, T-39, T-40, T-41, T-42, T-43, T-44, T-45, T-46, T-47, T-48, T-49, T-50, T-51, T-52, T-53, T-54, T-79, T-80, T-81, T-82, T-83, T-84, T-85, T-86, T-87, T-88, T-89, T-90, T-91, T-92, T-93, T-94, T-95, T-96, T-127, T-128, T-129, T-130, T-131, T-132, T-133, T-134, T-135, T-136, T-137, T-138, T-169, T-170, T-171, T-172, T-173, T-174, T-175, T-176, T-177, T-178, T-179, T-180, T-211, T-212, T-213, T-214, T-215, T-216, T-217, T-218, T-219, T-220, T-221, T-222, T-253, T-254, T-255, T-256, T-257, T-258, T-259, T-260, T-261, T-262, T-263, T-264, T-265, T-266, T-285, T-286, T-287, T-288, T-289, T-290, T-327, T-328, T-329, T-330, T-331 and T-332 are preferred. The mixtures T-37, T-38, T-39, T-40, T-41, T-42, T-79, T-80, T-81, T-82, T-83, T-84, T-85, T-86, T-87, T-88, T-89, T-90, T-127, T-128, T-129, T-130, T-131, T-132, T-175, T-176, T-177, T-178, T-179, T-180, T-217, T-218, T-219, T-220, T-221, T-222, T-285, T-286, T-287, T-288, T-289, T-290, T-327, T-328, T-329, T-330, T-331 and T-332 are more preferred and the mixtures T-38, T-39, T-40, T-42, T-80, T-81, T-82, T-84, T-85, T-86, T-87, T-88, T-89, T-90, T-127, T-128, T-129, T-130, T-131, T-132, T-176, T-177, T-178, T-180, T-218, T-219, T-220, T-222, T-286, T-287, T-288, T-290, T-328, T-329, T-330 and T-332 are most preferred. The mixtures T-86, T-87, T-88, T-90, T-128, T-129, T-130 and T-132 are utmost preferred.

Within the methods of the invention, in particular the method for synergistically increasing the health of a plant, the following mixtures are preferred: T-1, T-2, T-3, T-4, T-5, T-6, T-7, T-8, T-9, T-10, T-11, T-12, T-37, T-38, T-39, T-40, T-41, T-42, T-43, T-44, T-45, T-46, T-47, T-48, T-49, T-50, T-51, T-52, T-53, T-54, T-79, T-80, T-81, T-82, T-83, T-84, T-85, T-86, T-87, T-88, T-89, T-90, T-91, T-92, T-93, T-94, T-95, T-96, T-127, T-128, T-129, T-130, T-131, T-132, T-133, T-134, T-135, T-136, T-137, T-138, T-169, T-170, T-171, T-172, T-173, T-174, T-175, T-176, T-177, T-178, T-179, T-180, T-211, T-212, T-213, T-214, T-215, T-216, T-217, T-218, T-219, T-220, T-221, T-222, T-253, T-254, T-255, T-256, T-257, T-258, T-259, T-260, T-261, T-262, T-263, T-264, T-265, T-266, T-285, T-286, T-287, T-288, T-289, T-290, T-327, T-328, T-329, T-330, T-331 and T-332. The mixtures T-37, T-38, T-39, T-40, T-41, T-42, T-79, T-80, T-81, T-82, T-83, T-84, T-85, T-86, T-87, T-88, T-89, T-90, T-127, T-128, T-129, T-130, T-131, T-132, T-175, T-176, T-177, T-178, T-179, T-180, T-217, T-218, T-219, T-220, T-221, T-222, T-285, T-286, T-287, T-288, T-289, T-290, T-327, T-328, T-329, T-330, T-331 and T-332 are more preferred and the mixtures T-38, T-39, T-40, T-42, T-80, T-81, T-82, T-84, T-85, T-86, T-87, T-88, T-89, T-90, T-127, T-128, T-129, T-130, T-131, T-132, T-176, T-177, T-178, T-180, T-218, T-219, T-220, T-222, T-286, T-287, T-288, T-290, T-328, T-329, T-330 and T-332 are most preferred. The mixtures T-86, T-87, T-88, T-90, T-128, T-129, T-130 and T-132 are utmost preferred.

When used for synergistically increasing the health of a plant according to the invention, the following mixtures are preferred: T-1, T-2, T-3, T-4, T-5, T-6, T-7, T-8, T-9, T-10, T-11, T-12, T-37, T-38, T-39, T-40, T-41, T-42, T-43, T-44, T-45, T-46, T-47, T-48, T-49, T-50, T-51, T-52, T-53, T-54, T-79, T-80, T-81, T-82, T-83, T-84, T-85, T-86, T-87, T-88, T-89, T-90, T-91, T-92, T-93, T-94, T-95, T-96, T-127, T-128, T-129, T-130, T-131, T-132, T-133, T-134, T-135, T-136, T-137, T-138, T-169, T-170, T-171, T-172, T-173, T-174, T-175, T-176, T-177, T-178, T-179, T-180, T-211, T-212, T-213, T-214, T-215, T-216, T-217, T-218, T-219, T-220, T-221, T-222, T-253, T-254, T-255, T-256, T-257, T-258, T-259, T-260, T-261, T-262, T-263, T-264, T-265, T-266, T-285, T-286, T-287, T-288, T-289, T-290, T-327, T-328, T-329, T-330, T-331 and T-332. The mixtures T-37, T-38, T-39, T-40, T-41, T-42, T-79, T-80, T-81, T-82, T-83, T-84, T-85, T-86, T-87, T-88, T-89, T-90, T-127, T-128, T-129, T-130, T-131, T-132, T-175, T-176, T-177, T-178, T-179, T-180, T-217, T-218, T-219, T-220, T-221, T-222, T-285, T-286, T-287, T-288, T-289, T-290, T-327, T-328, T-329, T-330, T-331 and T-332 are more preferred and the mixtures T-38, T-39, T-40, T-42, T-80, T-81, T-82, T-84, T-85, T-86, T-87, T-88, T-89, T-90, T-127, T-128, T-129, T-130, T-131, T-132, T-176, T-177, T-178, T-180, T-218, T-219, T-220, T-222, T-286, T-287, T-288, T-290, T-328, T-329, T-330 and T-332 are most preferred. The mixtures T-86, T-87, T-88, T-90, T-128, T-129, T-130 and T-132 are utmost preferred.

All embodiments of the mixtures set forth above (including the respective preferences as set forth above) are hereinbelow referred to as “inventive mixture”.

All mixtures set forth above are also an embodiment of the present invention.

The inventive mixtures can further contain one or more insecticides, fungicides, herbicides and plant growth regulators.

The respective compounds (II) and (III) can also be used as their agriculturally acceptable salts and esters.

Referring to imidazolinone herbicides (compound II) or specific imidazolinone herbicide species in this application shall mean the compounds as mentioned above, as well as their a) salts, e.g. salts of alkaline or earth alkaline metals or ammonium or organoammonium salts, for instance, sodium, potassium, ammonium, preferably isopropyl ammonium etc.; b) respective isomers, e.g. stereo isomers such as the respective enantiomers, in particular the respective R-or S-enantiomers (including salts, ester, amides), c) respective esters, e.g. carboxylic acid C₁-C₈-(branched or non-branched) alkyl esters, such as methyl esters, ethyl esters, isopropyl esters, d) respective amides, e.g. carboxylic acid amides or carboxylic acid C₁-C₈-(branched or non-branched) mono or di alkyl amides, such as dimethylamides, diethylamides, diisopropyl amides or e) any other derivative which contains the above imidazolinone structures as structural moiety.

The imidazolinones may be present in the form of their racemate or in the form of the pure R-or S-enantiomers (including salts and esters as defined above). Very suitable imidazolinones are the R-isomers, e.g. R-imazamethabenz-methyl, R-imazamox, R-imazapic, R-imazapyr, R-imazaquin, R-imazethapyr, in particular R-imazamox. These compounds are known e.g. from U.S. Pat. No. 5,973,154 B (American Cyanamid Company) and U.S. Pat. No. 6,339,158 B1 (American Cyanamid Company).

Suitable salts of glyphosate include those salts of glyphosate, where the counterion is an agriculturally acceptable cation. Suitable examples of such salts are glyphosate-ammonium, glyphosate-diammonium, glyphosate-dimethylammonium, glyphosate-isopropylammonium, glyphosate-potassium, glyphosate-sodium, glyphosate-sesquisodium, glyphosate-sesquipotassium, glyphosate-trimethylsulphonium (sulphosate), glyphosate-trimesium as well as the ethanolamine and diethanolamine salts.

In a preferred embodiment, the salt of glyphosate is selected from glyphosate-diammonium, glyphosate-isopropylammonium, glyphosate-sesquisodium and glyphosata-trimethylsulphonium (sulphosate).

Suitable salts of glufosinate include those salts of glufosinate, where the counterion is an agriculturally acceptable cation. Suitable examples of such salts are glufosinate-ammonium and glufosinate-P.

The term “plants” generally comprises all plants of economic importance and/or men-grown plants. They are preferably selected from agricultural, silvicultural and ornamental plants, more preferably agricultural plants and silvicultural plants, utmost preferably agricultural plants. The term “plant (or plants)” is a synonym of the term “crop” which is to be understood as a plant of economic importance and/or a men-grown plant. The term “plant” as used herein includes all parts of a plant such as germinating seeds, emerging seedlings, herbaceous vegetation as well as established woody plants including all belowground portions (such as the roots) and aboveground portions.

The plants to be treated according to the invention are selected from the group consisting of agricultural, silvicultural, ornamental and horticultural plants, each in its natural or genetically modified form, more preferably from agricultural plants.

In a preferred embodiment, the plant to be treated according to the method of the invention is an agricultural plant. “Agricultural plants” are plants of which a part or all is harvested or cultivated on a commercial scale or which serve as an important source of feed, food, fibres (e.g. cotton, linen), combustibles (e.g. wood, bioethanol, biodiesel, biomass) or other chemical compounds. Agricultural plants also include vegetables. Thus, the term agricultural plants include cereals, e.g. wheat, rye, barley, triticale, oats, sorghum or rice; beet, e.g. sugar beet or fodder beet; leguminous plants, such as lentils, peas, alfalfa or soybeans; oil plants, such as rape, oil-seed rape, canola, juncea (Brassica juncea), linseed, mustard, olives, sunflowers, cocoa beans, castor oil plants, oil palms, ground nuts or soybeans; cucurbits, such as squashes, cucumber or melons; fiber plants, such as cotton, flax, hemp or jute; vegetables, such as cucumbers, spinach, lettuce, asparagus, cabbages, carrots, onions, tomatoes, potatoes, cucurbits or paprika; lauraceous plants, such as avocados, cinnamon or camphor; energy and raw material plants, such as corn, soybean, rape, canola, sugar cane or oil palm; corn; tobacco; nuts; coffee; tea; vines (table grapes and grape juice grape vines); hop; turf and natural rubber plants.

In a preferred embodiment, the plant to be treated is selected from the group consisting of soybean, sunflower, corn, cotton, canola, sugar cane, sugar beet, pome fruit, barley, oats, sorghum, rice and wheat.

In one embodiment, the plant to be treated according to the method of the invention is a horticultural plant. The term “horticultural plants” are to be understood as plants which are commonly used in horticulture—e.g. the cultivation of ornamentals, vegetables and/or fruits. Examples for ornamentals are turf, geranium, pelargonia, petunia, begonia and fuchsia. Examples for vegetables are potatoes, tomatoes, peppers, cucurbits, cucumbers, melons, watermelons, garlic, onions, carrots, cabbage, beans, peas and lettuce and more preferably from tomatoes, onions, peas and lettuce. Examples for fruits are apples, pears, cherries, strawberry, citrus, peaches, apricots and blueberries.

In one embodiment, the plant to be treated according to the method of the invention is an ornamental plant. “Ornamental plants” are plants which are commonly used in gardening, e.g. in parks, gardens and on balconies. Examples are turf, geranium, pelargonia, petunia, begonia and fuchsia.

In one embodiment, the plant to be treated according to the method of the invention is a silvicultural plants. The term “silvicultural plant” is to be understood as trees, more specifically trees used in reforestation or industrial plantations. Industrial plantations generally serve for the commercial production of forest products, such as wood, pulp, paper, rubber tree, Christmas trees, or young trees for gardening purposes. Examples for silvicultural plants are conifers, like pines, in particular Pinus spec., fir and spruce, eucalyptus, tropical trees like teak, rubber tree, oil palm, willow (Salix), in particular Salix spec., poplar (cottonwood), in particular Populus spec., beech, in particular Fagus spec., birch, oil palm and oak.

The term “plants” also includes plants which have been modified by breeding, mutagenesis or genetic engineering (transgenic and non-transgenic plants). Genetically modified plants are plants, which genetic material has been modified by the use of recombinant DNA techniques in a way that it cannot readily be obtained by cross breeding under natural circumstances, mutations or natural recombination. Typically, one or more genes have been integrated into the genetic material of a genetically modified plant in order to improve certain properties of the plant. Such genetic modifications also include but are not limited to targeted post-transitional modification of protein(s), oligo- or polypeptides e.g. by glycosylation or polymer additions such as prenylated, acetylated or farnesylated moieties or PEG moieties.

Plants as well as the propagation material of said plants, which can be treated with the inventive mixtures include all modified non-transgenic plants or transgenic plants, e.g. crops which tolerate the action of herbicides or fungicides or insecticides owing to breeding, including genetic engineering methods, or plants which have modified characteristics in comparison with existing plants, which can be generated for example by traditional breeding methods and/or the generation of mutants, or by recombinant procedures.

For example, mixtures according to the present invention can be applied (as seed treatment, foliar spray treatment, in-furrow application or by any other means) also to plants which have been modified by breeding, mutagenesis or genetic engineering including but not limiting to agricultural biotech products on the market or in development (cf. http://www.bio.org/speeches/pubs/er/agri_products.asp).

Plants that have been modified by breeding, mutagenesis or genetic engineering, e.g. have been rendered tolerant to applications of specific classes of herbicides. Tolerance to herbicides can be obtained by creating insensitivity at the site of action of the herbicide by expression of a target enzyme which is resistant to herbicide; rapid metabolism (conjugation or degradation) of the herbicide by expression of enzymes which inactivate herbicide; or poor uptake and translocation of the herbicide. Examples are the expression of enzymes which are tolerant to the herbicide in comparison to wild-type enzymes, such as the expression of 5-enolpyruvylshikimate-3-phosphate synthase (EPSPS), which is tolerant to glyphosate (see e.g. Heck et. al, Crop Sci. 45, 2005, 329-339; Funke et al., PNAS 103, 2006, 13010-13015; U.S. Pat. No. 5,188,642, U.S. Pat. No. 4,940,835, U.S. Pat. No. 5,633,435, U.S. Pat. No. 5,804,425, U.S. Pat. No. 5,627,061), the expression of glutamine synthase which is tolerant to glufosinate and bialaphos (see e.g. U.S. Pat. No. 5,646,024, U.S. Pat. No. 5,561,236) and DNA constructs coding for dicamba-degrading enzymes (see e.g. for general reference US 2009/0105077, and e.g. U.S. Pat. No. 7,105,724 for dicamba resistance in bean, maize (for maize see also WO 2008051633), cotton (for cotton see also U.S. Pat. No. 5,670,454), pea, potato, sorghum, soybean (for soybean see also U.S. Pat. No. 5,670,454), sunflower, tobacco, tomato (for tomato see also U.S. Pat. No. 5,670,454)). Gene constructs can be obtained, for example, from microorganism or plants, which are tolerant to said herbicides, such as the Agrobacterium strain CP4 EPSPS which is resistant to glyphosate; Streptomyces bacteria which are resistance to glufosinate; Arabidopsis, Daucus carota, Pseudomonoas ssp. or Zea mays with chimeric gene sequences coging for HDDP (see e.g. WO1996/38567, WO 2004/55191); Arabidopsis thaliana which is resistant to protox inhibitors (see e.g. US2002/0073443).

Examples of commercial available plants with tolerance to herbicides, are the corn varieties “Roundup Ready® Corn”, “Roundup Ready 2®” (Monsanto), “Agrisure GT®”, “Agrisure GT/CB/LL®”, “Agrisure GT/RW®”, “Agrisure 3000GT®” (Syngenta), “YieldGard VT Rootworm/RR2®” and “YieldGard VT Triple®” (Monsanto) with tolerance to glyphosate; the corn varieties “Liberty Link®” (Bayer), “Herculex I®”, “Herculex RW®”, “Herculex® Xtra” (Dow, Pioneer), “Agrisure GT/CB/LL®” and “Agrisure CB/LL/RW®” (Syngenta) with tolerance to glufosinate; the soybean varieties “Roundup Ready® Soybean” (Monsanto) and “Optimum GAT®” (DuPont, Pioneer) with tolerance to glyphosate; the cotton varieties “Roundup Ready® Cotton” and “Roundup Ready Flex®” (Monsanto) with tolerance to glyphosate; the cotton variety “FiberMax Liberty Link®” (Bayer) with tolerance to glufosinate; the cotton variety “BXN®” (Calgene) with tolerance to bromoxynil; the canola varieties “Navigator®” und “Compass®” (Rhone-Poulenc) with bromoxynil tolerance; the canola varierty “Roundup Ready® Canola” (Monsanto) with glyphosate tolerance; the canola variety “InVigor®” (Bayer) with glufosinate tolerance; the rice variety “Liberty Link® Rice” (Bayer) with glulfosinate tolerance and the alfalfa variety “Roundup Ready Alfalfa” with glyphosate tolerance. Further modified plants with herbicide are commonly known, for instance alfalfa, apple, eucalyptus, flax, grape, lentils, oil seed rape, peas, potato, rice, sugar beet, sunflower, tobacco, tomatom turf grass and wheat with tolerance to glyphosate (see e.g. U.S. Pat. No. 5,188,642, U.S. Pat. No. 4,940,835, U.S. Pat. No. 5,633,435, U.S. Pat. No. 5,804,425, U.S. Pat. No. 5,627,061); beans, soybean, cotton, peas, potato, sunflower, tomato, tobacco, corn, sorghum and sugarcane with tolerance to dicamba (see e.g. US 2009/0105077, U.S. Pat. No. 7,105,724 and U.S. Pat. No. 5,670,454); pepper, apple, tomato, hirse, sunflower, tobacco, potato, corn, cucumber, wheat, soybean and sorghum with tolerance to 2,4-D (see e.g. U.S. Pat. No. 6,153,401, U.S. Pat. No. 6,100,446, WO 05/107437, U.S. Pat. No. 5,608,147 and U.S. Pat. No. 5,670,454); sugarbeet, potato, tomato and tobacco with tolerance to gluphosinate (see e.g. U.S. Pat. No. 5,646,024, U.S. Pat. No. 5,561,236); canola, barley, cotton, juncea, lettuce, lentils, melon, millet, oats, oilseed rapre, potato, rice, rye, sorghum, soybean, sugarbeet, sunflower, tobacco, tomato and wheat with tolerance to acetolactate synthase (ALS) inhibiting herbicides, such as triazolopyrimidine sulfonamides, growth inhibitors and imidazolinones (see e.g. U.S. Pat. No. 5,013,659, WO 06/060634, U.S. Pat. No. 4,761,373, U.S. Pat. No. 5,304,732, U.S. Pat. No. 6,211,438, U.S. Pat. No. 6,211,439 and U.S. Pat. No. 6,222,100); cereal, sugar cane, rice, corn, tobacco, soybean, cotton, rapeseed, sugar beet and potato with tolerance to HPPD inhibitor herbicides (see e.g. WO 04/055191, WO 96/38567, WO 97/049816 and U.S. Pat. No. 6,791,014); wheat, soybean, cotton, sugar beet, rape, rice, corn, sorghum and sugar cane with tolerance to protoporphyrinogen oxidase (PPO) inhibitor herbicides (see e.g. US2002/0073443, US 20080052798, Pest Management Science, 61, 2005, 277-285). The methods of producing such herbicide resistant plants are generally known to the person skilled in the art and are described, for example, in the publications mentioned above. Further examples of commercial available modified plants with tolerance to herbicides “CLEARFIELD® Corn”, “CLEARFIELD® Canola”, “CLEARFIELD® Rice”, “CLEARFIELD® Lentils”, “CLEARFIELD® Sunlowers” (BASF) with tolerance to the imidazolinone herbicides.

Furthermore, plants are also covered that are by the use of recombinant DNA techniques capable to synthesize one or more insecticidal proteins, especially those known from the bacterial genus Bacillus, particularly from Bacillus thuringiensis, such as δ-endotoxins, e.g. CryIA(b), CryIA(c), CryIF, CryIF(a2), CryIIA(b), CryIIIA, CryIIIB(b1) or Cry9c; vegetative insecticidal proteins (VIP), e.g. VIP1, VIP2, VIP3 or VIP3A; insecticidal proteins of bacteria colonizing nematodes, e.g. Photorhabdus spp. or Xenorhabdus spp.; toxins produced by animals, such as scorpion toxins, arachnid toxins, wasp toxins, or other insect-specific neurotoxins; toxins produced by fungi, such Streptomycetes toxins, plant lectins, such as pea or barley lectins; agglutinins; proteinase inhibitors, such as trypsin inhibitors, serine protease inhibitors, patatin, cystatin or papain inhibitors; ribosome-inactivating proteins (RIP), such as ricin, maize-RIP, abrin, luffin, saporin or bryodin; steroid metabolism enzymes, such as 3-hydroxysteroid oxidase, ecdysteroid-IDP-glycosyl-transferase, cholesterol oxidases, ecdysone inhibitors or HMG-CoA-reductase; ion channel blockers, such as blockers of sodium or calcium channels; juvenile hormone esterase; diuretic hormone receptors (helicokinin receptors); stilben synthase, bibenzyl synthase, chitinases or glucanases. In the context of the present invention these insecticidal proteins or toxins are to be understood expressly also as pre-toxins, hybrid proteins, truncated or otherwise modified proteins. Hybrid proteins are characterized by a new combination of protein domains, (see, e.g. WO 02/015701). Further examples of such toxins or genetically modified plants capable of synthesizing such toxins are disclosed, e.g., in EP-A 374753, WO93/007278, WO 95/34656, EP-A427529, EP-A451878, WO03/18810 und WO03/52073. The methods for producing such genetically modified plants are generally known to the person skilled in the art and are described, e.g. in the publications mentioned above. These insecticidal proteins contained in the genetically modified plants impart to the plants producing these proteins tolerance to harmful pests from all taxonomic groups of athropods, especially to beetles (Coeloptera), two-winged insects (Diptera), and moths (Lepidoptera) and to nematodes (Nematoda). Genetically modified plants capable to synthesize one or more insecticidal proteins are, e.g., described in the publications mentioned above, and some of which are commercially available such as YieldGard® (corn cultivars producing the Cry1Ab toxin), YieldGard® Plus (corn cultivars producing Cry1Ab and Cry3Bb1 toxins), Starlink® (corn cultivars producing the Cry9c toxin), Herculex® RW (corn cultivars producing Cry34Ab1, Cry35Ab1 and the enzyme Phosphinothricin-N-Acetyltransferase [PAT]); NuCOTN® 33B (cotton cultivars producing the Cry1Ac toxin), Bollgard® I (cotton cultivars producing the Cry1Ac toxin), Bollgard® II (cotton cultivars producing Cry1Ac and Cry2Ab2 toxins); VIPCOT® (cotton cultivars producing a VIP-toxin); NewLeaf® (potato cultivars producing the Cry3A toxin); BtXtra®, NatureGard®, KnockOut®, BiteGard®, Protecta®, Bt11 (e.g. Agrisure® CB) and Bt176 from Syngenta Seeds SAS, France, (corn cultivars producing the Cry1Ab toxin and PAT enzyme), MIR604 from Syngenta Seeds SAS, France (corn cultivars producing a modified version of the Cry3A toxin, c.f. WO03/018810), MON 863 from Monsanto Europe S.A., Belgium (corn cultivars producing the Cry3Bb1 toxin), IPC531 from Monsanto Europe S.A., Belgium (cotton cultivars producing a modified version of the Cry1Ac toxin) and 1507 from Pioneer Overseas Corporation, Belgium (corn cultivars producing the Cry1F toxin and PAT enzyme).

Furthermore, plants are also covered that are by the use of recombinant DNA techniques capable to synthesize one or more proteins to increase the resistance or tolerance of those plants to bacterial, viral or fungal pathogens. Examples of such proteins are the so-called “pathogenesis-related proteins” (PR proteins, see, e.g. EP-A 392225), plant disease resistance genes (e.g. potato cultivars, which express resistance genes acting against Phytophthora infestans derived from the mexican wild potato Solanum bulbocastanum) or T4-lysozym (e.g. potato cultivars capable of synthesizing these proteins with increased resistance against bacteria such as Erwinia amylvora). The methods for producing such genetically modified plants are generally known to the person skilled in the art and are described, e.g. in the publications mentioned above.

Furthermore, plants are also covered that are by the use of recombinant DNA techniques capable to synthesize one or more proteins to increase the productivity (e.g. bio mass production, grain yield, starch content, oil content or protein content), tolerance to drought, salinity or other growth-limiting environmental factors or tolerance to pests and fungal, bacterial or viral pathogens of those plants.

Furthermore, plants are also covered that contain by the use of recombinant DNA techniques a modified amount of substances of content or new substances of content, specifically to improve human or animal nutrition, e.g. oil crops that produce health-promoting long-chain omega-3 fatty acids or unsaturated omega-9 fatty acids (e.g. Nexera® rape, DOW Agro Sciences, Canada).

Furthermore, plants are also covered that contain by the use of recombinant DNA techniques a modified amount of substances of content or new substances of content, specifically to improve raw material production, e.g. potatoes that produce increased amounts of amylopectin (e.g. Amflora® potato, BASF SE, Germany).

Particularly preferred modified plants suitable to be used within the methods of the present invention are those, which are rendered tolerant to at least one herbicide.

Particularly preferred modified plants suitable to be used within the methods of the present invention are those, which are resistant to at least one herbicide selected from glyphosate and glufosinate or an agriculturally acceptable salt thereof.

Especially preferred modified plants suitable to be used within the methods of the present invention are those, which are resistant to glyphosate or an agriculturally acceptable salt thereof.

In a preferred embodiment the inventive mixture as defined above is used for synergistically increasing the yield of a plant, wherein the mixture is applied to a soybean plant which is tolerant to at least one compound (II) and glyphosate.

In another preferred embodiment, the plants treated according to the methods of the invention are tolerant to at least one imidazolinone selected from the group consisting of imazamox, imazapic, imazapyr, imazethapyr, imazaquin and imazamethabenz-methyl.

The term “locus” is to be understood as any type of environment, soil, area or material where the plant is growing or intended to grow as well as the environmental conditions (such as temperature, water availability, radiation) that have an influence on the growth and development of the plant and/or its propagules.

In the terms of the present invention “mixture” means a combination of at least three compounds (active ingredients).

In the present case, a mixture used for increasing the health of a plant comprises one compound (I) and at least one compound (II) and one compound (III). In one embodiment, the mixture according to the invention comprises one compound (I) and one compound (II) and one compound (III). In another embodiment, the mixture according to the invention comprises one compound (I) and two compounds (II) and one compound (III).

The term “plant propagation material” is to be understood to denote all the generative parts of the plant such as seeds and vegetative plant material such as cuttings and tubers (e.g. potatoes), which can be used for the multiplication of the plant. This includes seeds, grains, roots, fruits, tubers, bulbs, rhizomes, cuttings, spores, offshoots, shoots, sprouts and other parts of plants, including seedlings and young plants, which are to be transplanted after germination or after emergence from soil, meristem tissues, single and multiple plant cells and any other plant tissue from which a complete plant can be obtained.

The term “propagules” or “plant propagules” is to be understood to denote any structure with the capacity to give rise to a new plant, e.g. a seed, a spore, or a part of the vegetative body capable of independent growth if detached from the parent. In a preferred embodiment, the term “propagules” or “plant propagules” denotes for seed.

The term “health of a plant” or “plant health” is defined as a condition of the plant and/or its products. As a result of the improved health, yield, plant vigor, quality and tolerance to abiotic or biotic stress are increased. Noteworthy, the health of a plant when applying the method according to the invention, is increased independently of the pesticidal properties of the active ingredients used because the increase in health is not based upon the reduced pest pressure but instead on complex physiological and metabolic reactions which result for example in an activation of the plant's own natural defense system. As a result, the health of a plant is increased even in the absence of pest pressure.

Accordingly, in an especially preferred embodiment of the method according to the invention, the health of a plant is increased both in the presence and absence of biotic or abiotic stress factors.

The above identified indicators for the health condition of a plant may be interdependent or they may result from each other. An increase in plant vigor may for example result in an increased yield and/or tolerance to abiotic or biotic stress.

It has to be emphasized that the above mentioned effects of the inventive mixtures, i.e. enhanced health of a plant, are also present when the plant is not under biotic stress and in particular when the plant is not under pest pressure. It is evident that a plant suffering from fungal or insecticidal attack produces a smaller biomass and leads to a reduced yield as compared to a plant which has been subjected to curative or preventive treatment against the pathogenic fungus or any other relevant pest and which can grow without the damage caused by the biotic stress factor. However, the methods according to the invention lead to an enhanced plant health even in the absence of any biotic stress. This means that the positive effects of the mixtures of the invention cannot be explained just by the fungicidal and/or herbicidal activities of the compounds (I), (II) and (III) and optionally compound (IV), but are based on further activity profiles. As a result, the application of the inventive mixtures can also be carried out in the absence of pest pressure.

Each listed plant health indicator listed below and which is selected from the groups consisting of yield, plant vigor, quality and tolerance to abiotic and/or biotic stress, is to be understood as a preferred embodiment of the present invention either each on its own or preferably in combination with each other.

According to the present invention, “increased yield” of a plant, in particular of an agricultural, silvicultural and/or horticultural plant means that the yield of a product of the respective plant is increased by a measurable amount over the yield of the same product of the plant produced under the same conditions, but without the application of the inventive mixture.

Increased yield can be characterized, among others, by the following improved properties of the plant:
increased plant weight
increased biomass such as higher overall fresh weight (FW) or higher total dry matter (TDM)
increased number of flowers per plant
higher grain and/or fruit yield
more tillers or side shoots (branches)
larger leaves
increased shoot growth
increased protein content
increased oil content
increased starch content
increased pigment content
increased chlorophyll content (chlorophyll content has a positive correlation with the plant's photosynthesis rate and accordingly, the higher the chlorophyll content the higher the yield of a plant)

In a preferred embodiment, the term “yield” refers to fruits in the proper sense, vegetables, nuts, grains and seeds.

“Grain” and “fruit” are to be understood as any plant product which is further utilized after harvesting, e.g. fruits in the proper sense, vegetables, nuts, grains, seeds, wood (e.g. in the case of silviculture plants), flowers (e.g. in the case of gardening plants, ornamentals) etc., that is anything of economic value that is produced by the plant.

According to the present invention, the yield is increased by at least 5%, preferable by 5 to 10%, more preferable by 10 to 20%, or even 20 to 30% compared to the untreated control plants or plants treated with pesticides in a way different from the method according to the present invention. In general, the yield increase may even be higher.

Another indicator for the condition of the plant is the plant vigor. The plant vigor becomes manifest in several aspects such as the general visual appearance.

Improved plant vigor can be characterized, among others, by the following improved properties of the plant:
improved vitality of the plant
improved plant growth
improved plant development
improved visual appearance
improved plant stand (less plant verse/lodging)
improved emergence
enhanced root growth and/or more developed root system
enhanced nodulation, in particular rhizobial nodulation
bigger leaf blade
bigger size
increased plant height
increased tiller number
increased number of side shoots
increased number of flowers per plant
increased shoot growth
increased root growth (extensive root system)
enhanced photosynthetic activity (e.g. based on increased stomatal conductance and/or increased CO₂ assimilation rate)
enhanced pigment content
earlier flowering
earlier fruiting
earlier and improved germination
earlier grain maturity
less non-productive tillers
less dead basal leaves
less input needed (such as fertilizers or water)
greener leaves
complete maturation under shortened vegetation periods
less fertilizers needed
less seeds needed
easier harvesting
faster and more uniform ripening
longer shelf-life
longer panicles
delay of senescence
stronger and/or more productive tillers
better extractability of ingredients
improved quality of seeds (for being seeded in the following seasons for seed production)
reduced production of ethylene and/or the inhibition of its reception by the plant.

According to the present invention, the plant vigor is increased by at least 5%, preferable by 5 to 10%, more preferable by 10 to 20%, or even 20 to 30% compared to the untreated control plants or plants treated with pesticides in a way different from the method according to the present invention. In general, the plant vigor increase may even be higher.

One result of an increased vigor is that the plants show a higher tolerance to phytoxic compounds. As result, in one embodiment of the invention, the inventive mixture is used for reducing the phytotoxic effects of agrochemicals.

Another indicator for the condition of the plant is the “quality” of a plant and/or its products. According to the present invention, enhanced quality means that certain plant characteristics such as the content or composition of certain ingredients are increased or improved by a measurable or noticeable amount over the same factor of the plant produced under the same conditions, but without the application of the mixtures of the present invention. Enhanced quality can be characterized, among others, by following improved properties of the plant or its product:
increased nutrient content
increased protein content
increased content of fatty acids
increased metabolite content
increased carotenoid content
increased sugar content
increased amount of essential amino acids
improved nutrient composition
improved protein composition
improved composition of fatty acids
improved metabolite composition
improved carotenoid composition
improved sugar composition
improved amino acids composition
improved or optimal fruit color
improved leaf color
higher storage capacity
higher processability of the harvested products.

According to the present invention, the quality of a plant and/or its products is increased by at least 5%, preferable by 5 to 10%, more preferable by 10 to 20%, or even 20 to 30% compared to the untreated control plants or plants treated with pesticides in a way different from the method according to the present invention. In general, the quality of a plant and/or its products increase may even be higher.

Another indicator for the condition of the plant is the plant's tolerance or resistance to biotic and/or abiotic stress factors. Biotic and abiotic stress, especially over longer terms, can have harmful effects on plants. Biotic stress is caused by living organisms while abiotic stress is caused for example by environmental extremes. According to the present invention, “enhanced tolerance or resistance to biotic and/or abiotic stress factors” means (1.) that certain negative factors caused by biotic and/or abiotic stress are diminished in a measurable or noticeable amount as compared to plants exposed to the same conditions, but without being treated with an inventive mixture and (2.) that the negative effects are not diminished by a direct action of the inventive mixture on the stress factors, e.g. by its fungicidal or insecticidal action which directly destroys the microorganisms or pests, but rather by a stimulation of the plants' own defensive reactions against said stress factors.

Negative factors caused by biotic stress such as pathogens and pests are widely known and range from dotted leaves to total destruction of the plant. Biotic stress can be caused by living organisms, such as pests (for example insects, arachnides, nematodes)-competing plants (for example weeds), microorganisms (such as phythopathogenic fungi and/or bacteria) and/or viruses.

Negative factors caused by abiotic stress are also well-known and can often be observed as reduced plant vigor (see above), for example: dotted leaves, “burned leaves”, reduced growth, less flowers, less biomass, less crop yields, reduced nutritional value of the crops, later crop maturity, to give just a few examples. Abiotic stress can be caused for example by:
extremes in temperature such as heat or cold (heat stress/cold stress)
strong variations in temperature
temperatures unusual for the specific season
drought (drought stress)
extreme wetness
high salinity (salt stress)
radiation (for example by increased UV radiation due to the decreasing ozone layer)
increased ozone levels (ozone stress)
organic pollution (for example by phythotoxic amounts of pesticides)
inorganic pollution (for example by heavy metal contaminants).

As a result of biotic and/or abiotic stress factors, the quantity and the quality of the stressed plants, their crops and fruits decrease. As far as quality is concerned, reproductive development is usually severely affected with consequences on the crops which are important for fruits or seeds. Synthesis, accumulation and storage of proteins are mostly affected by temperature; growth is slowed by almost all types of stress; polysaccharide synthesis, both structural and storage is reduced or modified: these effects result in a decrease in biomass (yield) and in changes in the nutritional value of the product.

According to the present invention, the plant's tolerance or resistance to biotic and/or abiotic stress is increased by at least 5%, preferable by 5 to 10%, more preferable by 10 to 20%, or even 20 to 30% compared to the untreated control plants or plants treated with pesticides in a way different from the method according to the present invention. In general, the plant's tolerance or resistance to biotic and/or abiotic stress increase may even be higher.

Advantageous properties, obtained especially from treated seeds, are e.g. improved germination and field establishment, better vigor and/or a more homogen field establishment.

As pointed out above, the above identified indicators for the health condition of a plant may be interdependent and may result from each other. For example, an increased resistance to biotic and/or abiotic stress may lead to a better plant vigor, e.g. to better and bigger crops, and thus to an increased yield. Inversely, a more developed root system may result in an increased resistance to biotic and/or abiotic stress. However, these interdependencies and interactions are neither all known nor fully understood and therefore the different indicators are described separately.

In one embodiment the inventive mixtures increases the yield of a plant or its product.

In a preferred embodiment of the invention, the inventive mixtures are used for increasing the plant weight and/or the plant biomass (e.g. overall fresh weight) and/or the grain yield and/or the number of tillers.

In another embodiment of the invention, the inventive mixtures are used for increasing the total dry matter (TDM) of a plant.

In another embodiment of the invention, the inventive mixtures are used for increasing the chlorophyll content of a plant is increased.

In another embodiment the inventive mixtures increases the vigor of a plant or its product.

In another embodiment the inventive mixtures increases the quality of a plant or its product.

In yet another embodiment the inventive mixtures increases the tolerance and/or resistance of a plant or its product against biotic stress.

In yet another embodiment the inventive mixture increases the tolerance and/or resistance of a plant or its product against abiotic stress.

In a preferred embodiment, the inventive mixtures increases the tolerance and/or resistance of a plant or its product against drought stress.

In another preferred embodiment, the inventive mixtures increases the tolerance and/or resistance of a plant or its product against cold stress.

In yet another preferred embodiment, the inventive mixtures increases the tolerance and/or resistance of a plant or its product against heat stress.

One of the most important factors for the increased resistance against biotic and abiotic stress is the stimulation of the plant's natural defense reactions after the application of the inventive mixtures according to the invention.

The inventive mixtures are employed by treating the plant, plant propagation material (preferably seed), soil, area, material or environment in which a plant is growing or may grow with an effective amount of the active compounds.

The application can be carried out in the absence of pest pressure and/or both before and after an infection of the materials, plants or plant propagation materials (preferably seeds) by pests.

In one embodiment of the invention, a mixture for increasing the health of a plant is applied at a growth stage (GS) between GS 00 and GS 73 BBCH of the treated plant.

In a preferred embodiment of the invention, a mixture for increasing the health of a plant is applied at a growth stage (GS) between GS 00 and GS 71 BBCH of the treated plant.

In an even more preferred embodiment of the invention, a mixture for increasing the health of a plant is applied at a growth stage (GS) between GS 12 and GS 49 BBCH of the treated plant.

In a most preferred embodiment of the invention, a mixture for increasing the health of a plant is applied at a growth stage (GS) between GS 12 and GS 16 BBCH of the treated plant.

The term “growth stage” (GS) refers to the extended BBCH-scale which is a system for a uniform coding of phenologically similar growth stages of all mono- and dicotyledonous plant species in which the entire developmental cycle of the plants is subdivided into clearly recognizable and distinguishable longer-lasting developmental phases.

The BBCH-scale uses a decimal code system, which is divided into principal and secondary growth stages. The abbreviation BBCH derives from the Federal Biological Research Centre for Agriculture and Forestry (Germany), the Bundessortenamt (Germany) and the chemical industry.

When preparing the mixtures, it is preferred to employ the pure active compounds, to which further active compounds against pests, such as insecticides, herbicides, fungicides or else herbicidal or growth-regulating active compounds or fertilizers can be added as further active components according to need.

As stated above, the inventive mixtures comprising compounds (I), (II) and (III) and optionally compound (IV) are used in “effective amounts”. This means that they are used in a quantity which allows to obtain the desired effect which is a synergistic increase of the health of a plant but which does not give rise to any phytotoxic symptom on the treated plant.

When applied according to the invention, the mixtures comprise, depending on various parameters such as the treated plant species, the weather conditions or the specific mixture:
of from 1 g/ha and 1500 g/ha of compound (I); preferably of from 5 g/ha and 750 g/ha of compound (I); more preferably of from 20 g/ha and 500 g/ha of compound (I) and most preferably of from 20 g/ha to 300 g/ha of compound (I);
of from 1 g/ha and 1500 g/ha of compound (II); preferably of from 5 g/ha and 750 g/ha of compound (II); more preferably of from 20 g/ha and 500 g/ha of compound (II) and most preferably of from 20 g/ha to 300 g/ha of compound (II); and
of from 5 g/ha and 8000 g/ha of compound (III); preferably of from 20 g/ha and 6000 g/ha of compound (III); more preferably of from 100 g/ha and 5000 g/ha of compound (III) and most preferably of from 250 g/ha to 2500 g/ha of compound (III);

In case the inventive mixture comprises a compound (IV), the application rate of compound (IV) is of from 1 g/ha and 1500 g/ha; preferably of from 5 g/ha and 750 g/ha; more preferably of from 20 g/ha and 500 g/ha and most preferably of from 20 g/ha to 300 g/ha.

As mentioned above, a variant of the present invention also comprises seed treatment with compound (II) followed by foliar spraying with compound (I).

Seed treatment can be made into the seedbox before planting into the field.

For seed treatment purposes, the weight ratio in the ternary or quaternary mixtures of the present invention generally depends on the properties of the compounds of the inventive mixtures.

In the treatment of plant propagation material (preferably seed), amounts of from 0.01 g to 3 kg, in particular amounts from 0.01 g to 1 kg of inventive mixtures are generally required per 100 kg of plant propagation material (preferably seed). In a preferred embodiment of the method according to the invention, amounts of from 0.01 g to 250 g of inventive mixtures are required per 100 kg of plant propagation material (preferably seed). In another preferred embodiment of the method according to the invention, amounts of from 0.01 g to 150 g of inventive mixtures are required per 100 kg of plant.

The compounds according to the invention can be present in different crystal modifications whose biological activity may differ. They are likewise subject matter of the present invention.

In all ternary and quaternary mixtures used according to the methods of the present invention, the compounds are employed in amounts which result in a synergistic effect.

All inventive mixtures are typically applied as compositions comprising one compound (I), at least one compound (II) and one compound (III). Optionally these compositions additionally comprise one compound (IV).

In a preferred embodiment, the pesticial composition for increasing the health of a plant comprises a liquid or solid carrier and a mixture as described above.

For use according to the present invention, the inventive mixtures can be converted into the customary formulations, for example solutions, emulsions, suspensions, dusts, powders, pastes and granules. The use form depends on the particular intended purpose; in each case, it should ensure a fine and even distribution of the mixtures according to the present invention. The formulations are prepared in a known manner (cf. U.S. Pat. No. 3,060,084, EP-A 707 445 (for liquid concentrates), Browning: “Agglomeration”, Chemical Engineering, Dec. 4, 1967, 147-48, Perry's Chemical Engineer's Handbook, 4th Ed., McGraw-Hill, New York, 1963, S. 8-57 und ff. WO 91/13546, U.S. Pat. No. 4,172,714, U.S. Pat. No. 4,144,050, U.S. Pat. No. 3,920,442, U.S. Pat. No. 5,180,587, U.S. Pat. No. 5,232,701, U.S. Pat. No. 5,208,030, GB2,095,558, U.S. Pat. No. 3,299,566, Klingman: Weed Control as a Science (J. Wiley & Sons, New York, 1961), Hance et al.: Weed Control Handbook (8th Ed., Blackwell Scientific, Oxford, 1989) and Mollet, H. and Grubemann, A.: Formulation Technology (Wiley VCH Verlag, Weinheim, 2001).

The agrochemical formulations may also comprise auxiliaries which are customary in agrochemical formulations. The auxiliaries used depend on the particular application form and active substance, respectively. Examples for suitable auxiliaries are solvents, solid carriers, dispersants or emulsifiers (such as further solubilizers, protective colloids, surfactants and adhesion agents), organic and anorganic thickeners, bactericides, anti-freezing agents, anti-foaming agents, if appropriate colorants and tackifiers or binders (e.g. for seed treatment formulations).

Suitable solvents are water, organic solvents such as mineral oil fractions of medium to high boiling point, such as kerosene or diesel oil, furthermore coal tar oils and oils of vegetable or animal origin, aliphatic, cyclic and aromatic hydrocarbons, e.g. toluene, xylene, paraffin, tetrahydronaphthalene, alkylated naphthalenes or their derivatives, alcohols such as methanol, ethanol, propanol, butanol and cyclohexanol, glycols, ketones such as cyclohexanone and gamma-butyrolactone, fatty acid dimethylamides, fatty acids and fatty acid esters and strongly polar solvents, e.g. amines such as N-methylpyrrolidone.

Solid carriers are mineral earths such as silicates, silica gels, talc, kaolins, limestone, lime, chalk, bole, loess, clays, dolomite, diatomaceous earth, calcium sulfate, magnesium sulfate, magnesium oxide, ground synthetic materials, fertilizers, such as, e.g. ammonium sulfate, ammonium phosphate, ammonium nitrate, ureas, and products of vegetable origin, such as cereal meal, tree bark meal, wood meal and nutshell meal, cellulose powders and other solid carriers.

Suitable surfactants (adjuvants, wetters, tackifiers, dispersants or emulsifiers) are alkali metal, alkaline earth metal and ammonium salts of aromatic sulfonic acids, such as ligninsoulfonic acid (Borresperse® types, Borregard, Norway) phenolsulfonic acid, naphthalenesulfonic acid (Morwet® types, Akzo Nobel, U.S.A.), dibutylnaphthalenesulfonic acid (Nekal® types, BASF, Germany), and fatty acids, alkylsulfonates, alkylarylsulfonates, alkyl sulfates, laurylether sulfates, fatty alcohol sulfates, and sulfated hexa-, hepta- and octadecanolates, sulfated fatty alcohol glycol ethers, furthermore condensates of naphthalene or of naphthalenesulfonic acid with phenol and formaldehyde, polyoxy-ethylene octylphenyl ether, ethoxylated isooctylphenol, octylphenol, nonylphenol, alkylphenyl polyglycol ethers, tributylphenyl polyglycol ether, tristearylphenyl polyglycol ether, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignin-sulfite waste liquid and proteins, denatured proteins, polysaccharides (e.g. methylcellulose), hydrophobically modified starches, polyvinyl alcohols (Mowiol® types, Clariant, Switzerland), polycarboxylates (Sokolan® types, BASF, Germany), polyalkoxylates, polyvinylamines (Lupasol® types, BASF, Germany), polyvinylpyrrolidone and the copolymers thereof. Examples for thickeners (i.e. compounds that impart a modified flowability to formulations, i.e. high viscosity under static conditions and low viscosity during agitation) are polysaccharides and organic and anorganic clays such as Xanthan gum (Kelzan®, CP Kelco, U.S.A.), Rhodopol® 23 (Rhodia, France), Veegum® (R.T. Vanderbilt, U.S.A.) or Attaclay® (Engelhard Corp., NJ, USA).

Bactericides may be added for preservation and stabilization of the formulation. Examples for suitable bactericides are those based on dichlorophene and benzylalcohol hemi formal (Proxel® from ICI or Acticide® RS from Thor Chemie and Kathon® MK from Rohm & Haas) and isothiazolinone derivatives such as alkylisothiazolinones and benzisothiazolinones (Acticide® MBS from Thor Chemie). Examples for suitable anti-freezing agents are ethylene glycol, propylene glycol, urea and glycerin. Examples for anti-foaming agents are silicone emulsions (such as e.g. Silikon® SRE, Wacker, Germany or Rhodorsil®, Rhodia, France), long chain alcohols, fatty acids, salts of fatty acids, fluoroorganic compounds and mixtures thereof.

Suitable colorants are pigments of low water solubility and water-soluble dyes. Examples to be mentioned und the designations rhodamin B, C. I. pigment red 112, C. I. solvent red 1, pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108.

Examples for tackifiers or binders are polyvinylpyrrolidons, polyvinylacetates, polyvinyl alcohols and cellulose ethers (Tylose®, Shin-Etsu, Japan).

Powders, materials for spreading and dusts can be prepared by mixing or concomitantly grinding the compounds (I) and/or (II) and, if appropriate, further active substances, with at least one solid carrier.

Granules, e.g. coated granules, impregnated granules and homogeneous granules, can be prepared by binding the active substances to solid carriers. Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, e.g., ammonium sulfate, ammonium phosphate, ammonium nitrate, ureas, and products of vegetable origin, such as cereal meal, tree bark meal, wood meal and nutshell meal, cellulose powders and other solid carriers.

Examples for Formulation Types are:

1. Composition Types for Dilution with Water

i) Water-Soluble Concentrates (SL, LS)

10 parts by weight of compounds of the inventive mixtures are dissolved in 90 parts by weight of water or in a water-soluble solvent. As an alternative, wetting agents or other auxiliaries are added. The active substance dissolves upon dilution with water. In this way, a formulation having a content of 10% by weight of active substance is obtained.

ii) Dispersible Concentrates (DC)

20 parts by weight of compounds of the inventive mixtures are dissolved in 70 parts by weight of cyclohexanone with addition of 10 parts by weight of a dispersant, e.g. polyvinylpyrrolidone. Dilution with water gives a dispersion. The active substance content is 20% by weight.

iii) Emulsifiable Concentrates (EC)

15 parts by weight of compounds of the inventive mixtures are dissolved in 75 parts by weight of xylene with addition of calcium dodecylbenzenesulfonate and castor oil ethoxylate (in each case 5 parts by weight). Dilution with water gives an emulsion. The composition has an active substance content of 15% by weight.

iv) Emulsions (EW, EO, ES)

25 parts by weight of compounds of the inventive mixtures are dissolved in 35 parts by weight of xylene with addition of calcium dodecylbenzenesulfonate and castor oil ethoxylate (in each case 5 parts by weight). This mixture is introduced into 30 parts by weight of water by means of an emulsifying machine (Ultraturrax) and made into a homogeneous emulsion. Dilution with water gives an emulsion. The composition has an active substance content of 25% by weight.

v) Suspensions (SC, OD, FS)

In an agitated ball mill, 20 parts by weight of compounds of the inventive mixtures are comminuted with addition of 10 parts by weight of dispersants and wetting agents and 70 parts by weight of water or an organic solvent to give a fine active substance suspension. Dilution with water gives a stable suspension of the active substance. The active substance content in the composition is 20% by weight.

vi) Water-Dispersible Granules and Water-Soluble Granules (WG, SG)

50 parts by weight of compounds of the inventive mixtures are ground finely with addition of 50 parts by weight of dispersants and wetting agents and prepared as water-dispersible or water-soluble granules by means of technical appliances (e.g. extrusion, spray tower, fluidized bed). Dilution with water gives a stable dispersion or solution of the active substance. The composition has an active substance content of 50% by weight.

vii) Water-Dispersible Powders and Water-Soluble Powders (WP, SP, SS, WS)

75 parts by weight of compounds of the inventive mixtures are ground in a rotor-stator mill with addition of 25 parts by weight of dispersants, wetting agents and silica gel. Dilution with water gives a stable dispersion or solution of the active substance. The active substance content of the composition is 75% by weight.

viii) Gel (GF)

In an agitated ball mill, 20 parts by weight of compounds of the inventive mixtures are comminuted with addition of 10 parts by weight of dispersants, 1 part by weight of a gelling agent wetters and 70 parts by weight of water or of an organic solvent to give a fine suspension of the active substance. Dilution with water gives a stable suspension of the active substance, whereby a composition with 20% (w/w) of active substance is obtained.

2. Composition Types to be Applied Undiluted

ix) Dustable Powders (DP, DS)

5 parts by weight of compounds of the inventive mixtures are ground finely and mixed intimately with 95 parts by weight of finely divided kaolin. This gives a dustable composition having an active substance content of 5% by weight.

x) Granules (GR, FG, GG, MG)

0.5 parts by weight of compounds of the inventive mixtures is ground finely and associated with 99.5 parts by weight of carriers. Current methods are extrusion, spray-drying or the fluidized bed. This gives granules to be applied undiluted having an active substance content of 0.5% by weight.

xi) ULV Solutions (UL)

10 parts by weight of compounds of the inventive mixtures are dissolved in 90 parts by weight of an organic solvent, e.g. xylene. This gives a composition to be applied undiluted having an active substance content of 10% by weight.

The agrochemical formulations generally comprise between 0.01 and 95%, preferably between 0.1 and 90%, most preferably between 0.5 and 90%, by weight of active substances. The compounds of the inventive mixtures are employed in a purity of from 90% to 100%, preferably from 95% to 100% (according to NMR spectrum).

The compounds of the inventive mixtures can be used as such or in the form of their compositions, e.g. in the form of directly sprayable solutions, powders, suspensions, dispersions, emulsions, oil dispersions, pastes, dustable products, materials for spreading, or granules, by means of spraying, atomizing, dusting, spreading, brushing, immersing or pouring. The application forms depend entirely on the intended purposes; it is intended to ensure in each case the finest possible distribution of the compounds present in the inventive mixtures.

Aqueous application forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. Alternatively, it is possible to prepare concentrates composed of active substance, wetter, tackifier, dispersant or emulsifier and, if appropriate, solvent or oil, and such concentrates are suitable for dilution with water.

The active substance concentrations in the ready-to-use preparations can be varied within relatively wide ranges. In general, they are from 0.0001 to 10%, preferably from 0.001 to 1% by weight of compounds of the inventive mixtures.

The compounds of the inventive mixtures may also be used successfully in the ultralow-volume process (ULV), it being possible to apply compositions comprising over 95% by weight of active substance, or even to apply the active substance without additives.

Various types of oils, wetters, adjuvants, herbicides, fungicides, other pesticides, or bactericides may be added to the active compounds, if appropriate not until immediately prior to use (tank mix). These agents can be admixed with the compounds of the inventive mixtures in a weight ratio of 1:100 to 100:1, preferably 1:10 to 10:1.

Compositions of this invention may also contain fertilizers such as ammonium nitrate, urea, potash, and superphosphate, phytotoxicants and plant growth regulators and safeners. These may be used sequentially or in combination with the above-described compositions, if appropriate also added only immediately prior to use (tank mix). For example, the plant(s) may be sprayed with a composition of this invention either before or after being treated with the fertilizers.

The compounds contained in the mixtures as defined above can be applied simultaneously, that is jointly or separately, or in succession, the sequence, in the case of separate application, generally not having any effect on the result of the control measures.

According to this invention, applying the compounds (I), (II) and (III) and optionally compound (IV) is to be understood to denote, that the compounds (I), (II) and (III) and optionally compound (IV) occur simultaneously at the site of action (i.e. plant, plant propagation material (preferably seed), soil, area, material or environment in which a plant is growing or may grow) in an effective amount.

This can be obtained by applying compounds (I), (II) and (III) and optionally compound (IV) simultaneously, either jointly (e.g. as tank-mix) or separately, or in succession, wherein the time interval between the individual applications is selected to ensure that the active substance applied first still occurs at the site of action in a sufficient amount at the time of application of the further active substance(s). The order of application is not essential for working of the present invention.

In the inventive mixtures, the weight ratio of the compounds generally depends from the properties of the compounds of the inventive mixtures.

The compounds of the inventive mixtures can be used individually or already partially or completely mixed with one another to prepare the composition according to the invention. It is also possible for them to be packaged and used further as combination composition such as a kit of parts.

In one embodiment of the invention, the kits may include one or more, including all, components that may be used to prepare a subject agrochemical composition. E.g., kits may include the compound (I), (II) and compound (III) and/or an adjuvant component and/or a further pesticidal compound (e.g. insecticide, fungicide or herbicide) and/or a growth regulator component). One or more of the components may already be combined together or pre-formulated. In those embodiments where more than two components are provided in a kit, the components may already be combined together and as such are packaged in a single container such as a vial, bottle, can, pouch, bag or canister. In other embodiments, two or more components of a kit may be packaged separately, i.e., not pre-formulated. As such, kits may include one or more separate containers such as vials, cans, bottles, pouches, bags or canisters, each container containing a separate component for an agrochemical composition. In both forms, a component of the kit may be applied separately from or together with the further components or as a component of a combination composition according to the invention for preparing the composition according to the invention.

The user applies the composition according to the invention usually from a predosage device, a knapsack sprayer, a spray tank or a spray plane. Here, the agrochemical composition is made up with water and/or buffer to the desired application concentration, it being possible, if appropriate, to add further auxiliaries, and the ready-to-use spray liquid or the agrochemical composition according to the invention is thus obtained. Usually, 50 to 500 liters of the ready-to-use spray liquid are applied per hectare of agricultural useful area, preferably 50 to 400 liters.

According to one embodiment, individual compounds of the inventive mixtures formulated as composition (or formulation) such as parts of a kit or parts of the inventive mixture may be mixed by the user himself in a spray tank and further auxiliaries may be added, if appropriate (tank mix).

In a further embodiment, either individual compounds of the inventive mixtures formulated as composition or partially premixed components, e.g. components comprising the compound (I) and compound (II) may be mixed by the user in a spray tank and further auxiliaries and additives may be added, if appropriate (tank mix).

In a further embodiment, either individual components of the composition according to the invention or partially premixed components, e.g. components comprising the compound (I) and compound (II) can be applied jointly (e.g. after tankmix) or consecutively. In one embodiment of the method according to the invention, the plants and/or plant propagules are treated simultaneously (together or separately) or subsequently with a mixture as described above. Such subsequent application can be carried out with a time interval which allows a combined action of the applied compounds. Preferably, the time interval for a subsequent application of compound (I), (II) and (III) and optionally compound (IV) ranges from a few seconds up to 3 months, preferably, from a few seconds up to 1 month, more preferably from a few seconds up to 2 weeks, even more preferably from a few seconds up to 3 days and in particular from 1 second up to 24 hours.

Herein, we have found that simultaneous, that is joint or separate, application of a compound (I), (II) and (III) and optionally compound (IV) or the successive application of compound (I), (II) and (III) and optionally compound (IV) allows an enhanced increase of the health of a plant compared to the control rates that are possible with the individual compounds (synergistic mixtures).

With respect to ternary mixtures, the weight ratio of compound (I) (=component 1) to compound (II) (=component 2) is preferably from 100:1 to 1:100, more preferably from 50:1 to 1:50, more preferably from 20:1 to 1:20 and in particular from 10:1 to 1:10. The utmost preferred ratio is 1:5 to 5:1. Within the ternary mixtures, the weight ratio of compound (I) (=component 1) to the further compound (III) (=component 3) is preferably from 100:1 to 1:100, more preferably from 50:1 to 1:50, more preferably from 20:1 to 1:20 and in particular from 10:1 to 1:10. The utmost preferred ratio is 1:5 to 5:1. Within the ternary mixtures, the weight ratio of compound (II) (=component 2) to the further compound (III) (=component 3) is preferably from 100:1 to 1:100, more preferably from 50:1 to 1:50, more preferably from 20:1 to 1:20 and in particular from 10:1 to 1:10. The utmost preferred ratio is 1:5 to 5:1.

In another embodiment of the invention, the mixture as described above is repeatedly applied. If this is the case, the application is repeated two to five times, preferably two times.

The inventive mixtures are employed by treating the plant, plant propagation material (preferably seed), soil, area, material or environment in which a plant is growing or may grow with an effective amount of the active compounds.

Compositions, which are especially useful for seed treatment are e.g.:

A Soluble concentrates (SL, LS)

D Emulsions (EW, EO, ES)

E Suspensions (SC, OD, FS)

F Water-dispersible granules and water-soluble granules (WG, SG)

G Water-dispersible powders and water-soluble powders (WP, SP, WS)

H Gel-formulations (GF)

I Dustable powders (DP, DS)

These compositions can be applied to plant propagation materials, particularly seeds, diluted or undiluted. The compositions in question give, after two-to-tenfold dilution, active substance concentrations of from 0.01 to 60% by weight, preferably from 0.1 to 40% by weight, in the ready-to-use preparations. Application can be carried out before or during sowing. Methods for applying or treating agrochemical compounds and compositions thereof, respectively, on to plant propagation material, especially seeds, are known in the art, and include dressing, coating, pelleting, dusting and soaking application methods of the propagation material (and also in furrow treatment). In a preferred embodiment, the compounds or the compositions thereof, respectively, are applied on to the plant propagation material by a method such that germination is not induced, e.g. by seed dressing, pelleting, coating and dusting.

In the treatment of plant propagation material (preferably seed), the application rates of the inventive mixture are generally for the formulated product (which usually comprises from 10 to 750 g/l of the active(s)).

The invention also relates to the propagation products of plants, and especially the seed comprising, that is, coated with and/or containing, a mixture as defined above or a composition containing the mixture of two or more active ingredients or a mixture of two or more compositions each providing one of the active ingredients. The plant propagation material (preferably seed) comprises the inventive mixtures in an amount of from 0.01 g to 10 kg per 100 kg of plant propagation material (preferably seed).

The separate or joint application of the compounds of the inventive mixtures is carried out by spraying or dusting the seeds, the seedlings, the plants or the soils before or after sowing of the plants or before or after emergence of the plants.

The following examples are intended to illustrate the invention, but without imposing any limitation.

### EXAMPLES

### Example 1

### Soybean

The field experiments were carried out at the Experimental Station of Crop Science Department, Escola Superior de Agricultura “Luiz de Queiroz” (ESALQ), University of Sao Paulo (USP) in ‘Piracicaba’, Brazil.

The soybean plant population was 300.000 plants per hectare, cultivars Monsoy-7908-RR with spacing between plant rows of 0.5 m. According to soil analysis, 84 kg/ha of P₂O₅ and 48 kg/ha of K₂O were used and applied at sowing. Sowing dates were Jan. 21, 2011. Trial set up included 4 replications for each treatment with 5 rows of plants with 10 m length. Foliar treatments were applied with a CO₂ equipment (knapsack sprayer), with five cone spray nozzles (nozzle spacing: 0.5 m), using 150 L/ha as an application volume.

The products used were Roundup® Ultra (ammonium glyphosate—715 g/kg—WG); PIVOT® (imazethapyr—100 g/L—CS) and Insignia® (pyraclostrobin 200 g/kg—WG). They were applied by foliar application during the BBCH growth stages 15 through 17. Subsequently, phytotoxicity (P), total dry matter (TDM) and chlorophyll content (CC) were evaluated.

The phytotoxicity was determined using visual notes (0 to 100%) as suggested by the European Weed Research Council (1964), using the untreated control plants (T1) as reference.

The chlorophyll content was measured in an indirect form using SPAD-502 [Minolta] equipment. Each measurement was based on the mean of 4 readings at random points inside of the parcel in the sampled leaf (i.e. the third youngest leaf that was completely developed) (INSKEEP; BLOOM, 1985).

Two plants per plot were sampled to evaluate the total dry matter (TDM), using the “Stover standard method” (destructive method in which the collected plants are dried with hot air which is forced to circulate at 60-65° C. during 72 hours).

All experiments were carried out under comparable conditions.

TABLE 1
Chlorohyll content, phytotoxicity and total dry matter after a treatment
according to the invention. Soybean Monsoy-7908-RR. ESALQ/USP. Season
2010/2011.

| | | DR | | TDM | | CC T1 Δ | CC T5 Δ | TDM T5 Δ |
|---|---|---|---|---|---|---|---|---|
| T | Treatment | FT | CC (mg/L) | (g) | P (%) | (%) | (%) | (%) |
| 1 | Untreated | / | 13 | 14 | 0 | | | |
| | Control | | | | | | | |
| 2 | Roundup ® Ultra | 1.5 | 15 | 17 | 0 | +15 | | |
| 3 | Pivot ® | 1.0 | 12 | 16 | 13 | −5 | | |
| 4 | Insignia ® | 0.4 | 15 | 21 | 0 | +21 | | |
| 5 | Roundup Ultra ® | 1.5 | 13 | 16 | 10 | −1 | | |
| | + Pivot ® | 1.0 | | | | | | |
| 6 | Roundup Ultra ® | 1.5 | 15 | 22 | 0 | +17 | +18 | +36 |
| | + Pivot ® | 1.0 | | | | | | |
| | + Insignia ® | 0.4 | | | | | | |

T = Treatment No.;
DR FT = Dose Rate at Foliar Treatment (× L or kg/ha);
CC = Chlorophyll Content (mg L⁻¹; 28 days after application),
TDM = Total Dry Matter (g per 2 plants; 31 days after application),
P = Phytotoxicity (%; 10 days after application);
CC T1 = % change of CC in relation to the untreated control (= T1);
CC T5 = % change of CC in relation to the mixture of Roundup ® Ultra + Pivot ® (= T5);
TDM T5 = % increase of TDM in relation to the mixture of Roundup ® Ultra + Pivot ® (= T5).

The positive and surprising influence of the inventive mixture on the health of a plant gets especially clear when comparing T6 with T5. As can be seen in table 1, the method according to the invention (T6) resulted in a strong increase in chlorophyll content (+18%) and total dry matter (+36%) in relation to the treatment T5. In addition, the observed phytotoxicity of T5 was, at the same time, reduced to 0% in T6.

This is very surprising because it could not have been expected by the person skilled in the art that the mixture according to the invention (T6) would be able to raise the health of the treated plants to values which are comparable to those obtained when pyraclostrobin was applied alone (T4). It was highly surprising that the addition of a single compound to a complex mixture was capable of ruling out all the negative effects that the two herbicides caused (T5) and which led to an increased phytotoxicity, a decrease in chlorophyll content and a significantly lower total dry matter.

Actually, the contrary would have been expected due to the presence of imazethapyr (Pivot®) in the inventive mixture which had a clearly negative impact on chlorophyll content (−5%) and which increased phytotoxicity by +13% compared to the untreated control (T3). The obtained data, however, shows that the inventive mixture is able to overrule the negative impact of imazethapyr just as if it was not applied at all.

1-15. (canceled)

16. An agrochemical mixture for increasing the health of a plant, comprising as active compounds:
1) a fungicidal compound (I) selected from the group of strobilurins consisting of pyraclostrobin, azoxystrobin, dimoxystrobin, enestroburin, fluoxastrobin, kresoxim-methyl, metominostrobin, orysastrobin, picoxystrobin, pyribencarb, trifloxystrobin, pyrametostrobin, pyraoxystrobin, coumoxystrobin, coumethoxystrobin, triclopyricarb (=chlorodincarb), fenaminostrobin (=diclofenoxystrobin), flufenoxystrobin, 2-(2-(6-(3-chloro-2-methyl-phenoxy)-5-fluoro-pyrimidin-4-yloxy)-phenyl)-2-methoxyimino-N-methyl-acetamide, 3-methoxy-2-(2-(N-(4-methoxy-phenyl)-cyclopropane-carboximidoylsulfanylmethyl)-phenyl)-acrylic acid methyl ester, methyl (2-chloro-5-[1-(3-methylbenzyloxyimino)ethyl]benzyl)carbamate and 2-(2-(3-(2,6-dichlorophenyl)-1-methyl-allylideneaminooxymethyl)-phenyl)-2-methoxyimino-N methyl-acetamide;
2) at least one herbicidal compound (II) selected from the group of imidazolinones consisting of imazamethabenz-methyl, imazamox, imazapic, imazapyr, imazaquin and imazethapyr; or an agriculturally acceptable salt thereof;
3) a second herbicidal compound (III) selected from the group consisting of glyphosate and glufosinate; or an agriculturally acceptable salt thereof;
in synergistically effective amounts.

17. The mixture according to claim 16, wherein the mixture additionally comprises a second fungicide (compound IV) selected from the groups consisting of:
A) a strobilurine selected from the group consisting of:
pyraclostrobin, azoxystrobin, dimoxystrobin, enestroburin, fluoxastrobin, kresoxim-methyl, metominostrobin, orysastrobin, picoxystrobin, pyribencarb, trifloxystrobin, pyrametostrobin, pyraoxystrobin, coumoxystrobin, coumethoxystrobin, triclopyricarb (=chlorodincarb), fenaminostrobin (=diclofenoxystrobin), flufenoxystrobin, 2-(2-(6-(3-chloro-2-methyl-phenoxy)-5-fluoro-pyrimidin-4-yloxy)-phenyl)-2-methoxyimino-N-methyl-acetamide, 3-methoxy-2-(2-(N-(4-methoxy-phenyl)-cyclopropane-carboximidoylsulfanylmethyl)-phenyl)-acrylic acid methyl ester, methyl (2-chloro-5-[1-(3-methylbenzyloxyimino)ethyl]benzyl)carbamate and 2-(2-(3-(2,6-dichlorophenyl)-1-methyl-allylideneaminooxymethyl)-phenyl)-2-methoxyimino-N methyl-acetamide; and
B) a carboxamide selected from the group consisting of:
benodanil, bixafen, boscalid, carboxin, fenfuram, flutolanil, fluxapyroxad, furametpyr, isopyrazam, mepronil, oxycarboxin, penflufen, penthiopyrad, sedaxane, thifluzamide, N-(4′-trifluoromethylthiobiphenyl-2-yl)-3 difluoromethyl-1-methyl-1H pyrazole-4-carboxamide and N-(2-(1,3,3-trimethyl-butyl)-phenyl)-1,3-dimethyl-5 fluoro-1H-pyrazole-4 carboxamide and fluopyram.

18. The mixture according to claim 16, wherein the mixture additionally comprises fluxapyroxad as a compound (IV).

19. The mixture according to claim 16, wherein compound (I) is selected from the group consisting of pyraclostrobin, azoxystrobin, picoxystrobin and trifloxystrobin.

20. The mixture according to claim 16, wherein compound (I) is pyraclostrobin.

21. The mixture according to claim 16, wherein compound (II) is selected from the group consisting of imazapic, imazapyr, imazethapyr and imazamox.

22. The mixture according to claim 16, wherein compound (II) is selected from the group consisting of imazapic and imazapyr.

23. The mixture according to claim 16, wherein compound (III) is glyphosate or an agriculturally acceptable salt thereof.

24. An agrochemical composition for increasing the health of a plant, comprising a liquid or sold carrier and a mixture as defined in claim 16.

25. A method for synergistically increasing the health of a plant, which is tolerant to a herbicidal compound (III), wherein the plant, the locus where the plant is growing or is expected to grow or plant propagation material from which the plant grows is treated with an effective amount of a mixture as defined in claim 16.

26. The method according to claim 10, wherein the mixture, as defined in claim 16, is repeatedly applied.

27. The method of claim 25 wherein a plant's tolerance against abiotic stress is increased wherein the treated plant is tolerant to a herbicidal compound (III).

28. The use according to claim 26, wherein the plant is selected from the group consisting of soybean, sunflower, corn, cotton, canola, sugar cane, sugar beet, pome fruit, barley, oats, sorghum, rice and wheat.

29. The method of claim 26, wherein the mixture is applied to a soybean plant which is tolerant to at least one compound (II) and glyphosate.

30. The method of claim 26, wherein the mixture additionally comprises fluxapyroxad as a compound (IV).

31. The method of claim 26, wherein compound (I) is selected from the group consisting of pyraclostrobin, azoxystrobin, picoxystrobin and trifloxystrobin.

32. The method of claim 26, wherein compound (I) is pyraclostrobin.

33. The method of claim 26, wherein compound (II) is selected from the group consisting of imazapic, imazapyr, imazethapyr and imazamox.

34. The method of claim 26, wherein compound (II) is selected from the group consisting of imazapic and imazapyr.

35. The method of claim 26, wherein compound (III) is glyphosate or an agriculturally acceptable salt thereof.
